(19) United States
(12) Patent Application Publication
(10) Pub. No.: US 2007/0096447 A1
(43) Pub. Date: May 3, 2007

(54) Smart seatbelt control system

(76) Inventor: Joseph Akwo Tabe, Silver Spring, MD (US)

Correspondence Address: JOSEPH A. TABE;SUITE 717, 11700 OLD COLUMBIA PIKE, SILVER SPRING, MD, 20904, US

(21) Appl. No.: 11/640,726

(22) Filed: Dec. 18, 2006

Related U.S. Application Data
(63) Continuation-in-part of application No. 10/680,826, filed on Oct. 7, 2003, now abandoned.

(51) Int. Cl. E05F 15/00; B60R 21/00; B60R 21/015

(52) U.S. Cl. 280/735; 280/806; 180/268; 701/45; 180/273

(57) ABSTRACT

An apparatus for preventing occupant injury during accident has various features to ensure safety. A sensor 70, detecting seat belt engagement is provided. In addition, there is a means for varying the tension of a seatbelt 17, depending upon the weight of the occupant 110 and the speed of the vehicle carrying the occupant 110. When the occupant 110 seats on any of the seats 17, the load cell switch 18 will close, allowing the load cell output energy to energize the control module 25. The control module 25 will then enables the counter 50 to count the number of closed load cell switches 18. The control module 25 further enables an optoisolator switch configured with the sensor 70 to then energize a latching relay 80 operatively configured to check the seat belt latching of all occupied seats 10 with closed load cell switches 18, to assure occupants safety. The load cells are configured with strain gauges and temperature sensors to ensure human occupants. Such that, when the switch 18 for the occupied seat 10 is closed, the latching relay 80 circuit is energized so that the seat belt 17 for the occupied seat location is checked for buckling. The latching relay 80 circuit and the counter 50 circuit are operatively configured and closed only when an occupant 110 takes any of the seats 10. The latching relay switch 85 is only energized when the counter circuit 50 is closed.

This application is a Continuation-In-Part of application Ser. No. 10/680,826, filed in Oct. 7, 2003. Application Ser. No. 09/959,502, filed on Oct. 18, 2001, now abandoned. Application Ser. No. 09/959,503, filed on Oct. 18, 2001. Application Ser. No. 09/692,096, filed on Oct. 20, 2000, now abandoned. Applicant hereby claims priority under 35 U.S.C 119 of U.S. Provisional Application Ser. No. 60/052,435, filed Jul. 14, 1997, U.S. patent application Ser. No. 08/953,503 filed Oct. 17, 1997, U.S. Provisional Application Ser. No. 60/079,496 filed Mar. 26, 1998, World Intellectual Property Organization Application Serial Number WO99/48729 and Patent Corporation Treaty Application Serial Number U.S99/06666. The improvement for the instant invention is based on the same concept as the provisional application Ser. No. 60/052,435, filed Jul. 14, 1997, Ser. No. 60/079,496 filed on 26 Mar. 1998 and of PCT Application No. PCT/US99/06666.

### FIELD OF THE INVENTION

The smart seat belt control system is design to electronically work with the computer system for the advance weight responsive supplemental restraint computer system. It is an intelligent device for the new century, designed to totally erase vehicular fatalities that are incurred due to human negligence in all types of accidents. The brain of this device is linked to the concept and theory governing the fact that; all safety devices for all types of vehicles should not discriminatorily protect the driver or frontal seat occupants alone. The theory states that, every individual in a moving vehicle is an occupant and every occupant may incur injuries in a collision. Therefore, every occupant on any seat inside the vehicle must be protected.

### TECHNICAL FIELD OF THE INVENTION

Seat belts have been used for many years to prevent passengers from injuries in car crashes. Still, people are not paying attention to the importance of the use of the seat belts. Many loved ones have passed away, and many have been injured. The government has tried to make seat belt buckling a law, that all passengers wear their seat belts when riding in a vehicle. Yet, people chose to ride without obeying these laws. Therefore, it is very important to see that seat belt technologies be advanced to include these laws. However, these advanced technologies will provide means for locking the seat belt connectors when connected with the vehicle in motion, to prevent occupants from unlatching the seat belts.

It is also very important to see that, when a passenger is on any of the seats and not wearing the seat belt, means is provided to shut off the engine until the said occupant is belted. It is also very important to see that, once the occupant is belted, means be provided to alert the driver of the vehicle know of the occupants attempt to unlatch the seat belt while the vehicle is in motion. It is also very important to see that, technologies be advanced to prevent the live of our love one's like our beloved Princess. It is for these reasons, “The death of the beloved Princess,” and the public information about the cause of her death, and by her not wearing seat belt that, the applicant has developed a technology that will prevent such fatalities in the future. This technology if applied, could have kept the Princess on her seat and reduce the amount of injuries that she sustained. The common incessant has been “Speed Kills,” ‘Buckle Up,” “Don't Drink and Drive.” These are simplistic wordings and attempts need to be made to enhance these doctrines on our daily practices. Therefore, it is the object of this invention to provide means of buckling up before the vehicle could be put in motion. It is another object of this invention to see that all drivers and passengers take precautionary measures and wear their seat belts before the vehicle could be engaged in motion.

### BACKGROUND OF THE INVENTION

Despite the increase of the use of seat belts, the estimates of occupants without seatbelt use for 1997 alone were 44 percent passenger car occupants and 49 percent light truck occupants who where involved in fatal crashes without wearing their seat belts. In 1998, about 19 million more people in the United State cultivated the habit of buckling up, but this did not erase the fact that failure to wear a safety belt by others will not contribute to the more fatalities that are overtaking single traffic safety related accidents. Considering the estimation that safety belts have save 9,500 lives each year leaves us with the believe that if more people from the 19 million wore their seat belts, more people could have been saved.

The traditional lab and shoulder belt does not protect occupants when the occupants are not belted. That is the primary reason the airbags and the smart airbags are designed to assist in these conditions. However, the design of the advanced weight responsive supplemental restraint computer system in “Smart Airbag” and the design of the present invention in “smart seatbelt control system” are appropriate in responding to all accidental conditions and to take care of the existing problems. The smart seatbelt control system “SSCS” includes sensors within the seats fixed surfaces and the floor of the vehicle to determine the occupied seats and also the positions of the occupants to enable signal communication thereof. Preventing the vehicle from engaging in motion when any of the occupants is unbelted is the technology behind the smart seatbelt control system, which reduces the risk associated with driving without the seatbelt being buckled. The present invention further eliminates injuries from the after effects of accidents. By letting the seat belt work in collaboration with the airbag, the seat belt appropriation with the airbag is timely, and allows the airbag reaction to collisions be very effective and also prevents passengers from falling forward when an impact is enabled.

In order to avoid some of the above problems, related prior art devices have incorporated measurement systems into the seats of some vehicles to gather information about the occupant and to operate the air bag in accordance with that information. These systems generally represent a simple “on” or “off” selection. First, if an occupant is not located in the seat, or does not trigger certain secondary detectors, the restraint system is disabled. If the detector properly senses the occupant in the vehicle, the air bag is simply “enabled”. These systems have no way of identifying a changing occupant and correcting the occupant's changing data.

This is exemplified by U.S. Pat. No. 3,861,710, to Okubo, issued Jan. 21, 1975, which shows an incremental airbag deployment through incremental signal communication, but does not show how occupants are classified to enable variable deployment of the airbag U.S. Pat. No. 4,806,713, issued Feb. 21, 1989, to Krug et al., which shows a seat contact switch for generating a “seat occupied” signal when an individual is sensed atop a seat. The Krug et al. Device does not have the ability to measure the mass of the seated individual.

U.S. Pat. No. 5,071,160, issued Dec. 10, 1991, to White et al., provides the next iteration of this type of system. A weight sensor in the seat, in combination with movement detectors, determines if it is necessary to deploy an air bag. If an air bag is deployed, the weight sensor determines what level of protection is needed and a choice is made between deploying one or two canisters of propellant. First, the weight sensor is located in the seat itself, which inherently leads to inaccurate readings. Second, the level of response has only a handful of reaction levels, thus the occupant not corresponding to one of these levels may be injured due to improper correlation of deployment force used to inflate the air bag.

U.S. Pat. No. 5,161,820, issued Nov. 10, 1992, to Vollmer, describes a control unit for the intelligent triggering of the propellant charge for the air bag when a triggering event is detected. Vollmer's device provides a multiplicity of sensors located around the occupant seat so as to sense the presence or absence of a sitting, standing, or kneeling occupant. The Vollmer device is incapable of sensing varying masses of occupants and deploying the air bag with force corresponding to the specific occupant weight. Rather, the Vollmer seat and floor sensors ascertain whether a lightweight object, such as a suitcase, is present or a relatively heavier human being. None of the above inventions and patents, taken either singly or in combination, teaches or suggests the present invention.

U.S. Pat. No. 5,232,243, to Blackburn, et al, issued Aug. 3, 1993, uses a film with electrical characteristics with changeable state. Blackburn, et al apparatus teaches a system that sends signals indicative of occupant's presence, but would not classify the occupants to enable a deployment force that would not cause further injury to the occupant.

U.S. Pat. No. 5,330,226, to Gentry, et al., issued Jul. 19, 1994, teaches an apparatus for controlling actuation of occupant restraint system and includes displacement sensors on the dashboard and an infrared sensor on the headliner for sensing the location of the occupant. The invention of Gentry, et al. has no way of classifying changing occupants to enable variable force airbag deployment to protect occupants without causing any further injury to the occupants.

U.S. Pat. No. 5,413,378, to Steffens, Jr., et al, issued May 9, 1995, uses position sensors and weight sensors to sense occupants, but the deployment of the airbag is controlled by a controller selecting a discrete control zone to regulate a vent valve. Steffens, Jr., et al, fails to implement a system that is capable of sensing occupant's actual weight measurement and set airbag deployment based on the data. Besides, the system of Steffens, Jr., et al, has no way of classifying changing occupants.

U.S. Pat. No. 5,707,078, to Swanberg, et al., issued Jan. 13, 1998, teaches airbag with adjustable cushion inflation, which includes a valve member in a module to change the size of the inflation outlet through which inflation fluid flows into the airbag cushion, but is not controlled by the occupant's weight. Thus, the invention of Swanberg, et al. fails to teach airbag assembly that is configured with a classification system to produce a device that would enable airbag deployment at a force that would not cause further injury to the occupant.

U.S. Pat. No. 5,746,467, to Jesadanont, issued May 5, 1998, directed to automatic safety car seat by using tension springs so that the backrest is pushed recline backward due to the action of the spring, still fails to teach seatbelt/airbag assembly that is configured with a classification system to produce a device that would enable seatbelt tension/airbag deployment at a force that would not cause further injury to the occupant.

U.S. Pat. No. 5,785,347, to Adolph, et al., issued Jul. 28, 1998, directed to occupant sensing and crash behavior system which determines the presence and location of an occupant to enable the deployment of an airbag, but fails to teach airbag assembly that is configured with a classification system to produce a device that would enable seatbelt tension/airbag deployment at a force proportionate to the occupant's weight and that would not cause further injury to the occupant.

U.S. Pat. No. 5,892,193, to Norton, issued Apr. 6, 1999, directed to compact crash sensing switch with air ducks and diagnostic system configured with crash sensors, latching circuit, and firing circuit. The invention of Norton has no way of classifying changing occupants to enable variable force seatbelt/airbag deployment to protect occupants without causing any further injury to the occupants.

U.S. Pat. No. 5,895,071, to Norton, issued Apr. 20, 1999, directed to compact crash sensing switch with air ducks and diagnostic system configured with crash sensors, latching circuit, and firing circuit. The invention of Norton has no way of classifying changing occupants to enable variable force seatbelt/airbag deployment to protect occupants without causing any further injury to the occupants.

U.S. Pat. No. 6,161,439, to Stanley, issued Dec. 19, 2000, directed to seatbelt tension prediction system configured with an accelerometer and a seat weight sensor having an output signal responsive to the force exerted by a mass on the seat by calculating the average mass reading to predict the exerting force on the seat, but does not have the ability to measure the actual mass of the seated individual and has no way of classifying changing occupants to enable variable force seatbelt/airbag deployment to protect occupants during an accident without causing any further injury to the occupants.

U.S. Pat. No. 6,259,167, to Norton, issued Jul. 10, 2001, still was filed only after the parent application of the current invention was made public, though failed in its entirety to show how occupant's data could be monitored and corrected.

U.S. Pat. No. 6,260,879, to Stanley, issued Jul. 17, 2001, directed to air bag suppression system using a weight sensor, a seat belt tension monitor, and a capacitive sensor for controlling the inflation of an air bag, but does not have the ability to measure the actual mass of the seated individual and has no way of classifying changing occupants to enable variable force seatbelt/airbag deployment to protect occupants during an accident without causing any further injury to the occupants.

U.S. Pat. No. 6,407,347, to Blakesley, issued Jul. 18, 2002, though attempted to use strain gauges after the parent application of the current invention was filed, still fails to distinguish a proper means by which occupants data could be monitored.

U.S. Pat. No. 6,677,538, to Cook, Jr. et al, though uses strain gauges for a vehicle weight classification system, the approach of Cook, Jr., et al. is limited to using analog signal processing technique without revealing a proper means by which occupant's weight could be monitored and the data properly control to keep the occupants from sustaining body injury during an accident. Besides, Cook, Jr., et. al., issued Jan. 13, 2004, This application was filed only after the parent application of the current invention was made public, but still fails to show how occupants data could be corrected.

U.S. Pat. No. 6,609,054, to Michael, issued Aug. 19, 2003, teaches a classification system that classifies vehicle occupants based on data from an array of sensors and modules are used to for making airbag deployment force decision, airbag deployment direction, or whether not to deploy the airbag. The decisions by Michael teachings for enabling airbag deployment are insufficient in scope to properly deploy the airbag without causing any more injury to the occupants

U.S. Pat. No. 6,695,344, to Constantin, issued Feb. 24, 2004, teaches an airbag module with a predefined outlet opening for the airbag. The module includes a reinforcement ring for the airbag. Constantin's teachings fail to show how the outlet opening is influenced by the occupant's weight to enable a proportionate deployment force for the airbag.

U.S. Pat. No. 7,011,338, to Midorikawa, et al., issued Mar. 14, 2006, teaches a seatbelt device which prevents an occupant from hitting his face against an airbag during deployment by taking up seatbelt slack before a collision. However, tensioning the occupant prior to collision without a predetermined tensile force that is proportionate to the occupant's weight will only cause further injury to the occupant at the time/before the occupant is met with the airbag.

U.S. Pat. No. 7,047,825, to Curtis, et al., issued May 23, 2006, teaches weight sensor assembly for measuring weight on a vehicle seat. The sensor assembly is mounted between the seat bottom frame and a seat mounting member. Though Coutis, et al., fails to use EPROM for monitoring and classifying changing occupants, their teachings seems to be a reflection of publication by World Intellectual Property Organization, Application Number WO 99/48729 and Patent Corporation Treaty, Application Number US99/06666 originally invented by applicant of the present invention.

### SUMMARY OF THE INVENTION

The smart seat belt control system works very closely with the smart air bag in the advanced weight responsive supplemental restraint computer system. When the ignition switch is turn on, the computer system will read the information from all the load cells. If the computer picks any weight presents on any of the load cells, it will record a “1” in the memory for each assigned load cell that has an occupant. The Spring Control at the Isolator Switch will then deploy a spring carrying current that monitors the contacts of each seat belt connectors. When the current is restricted or cutoff the spring will retract to unlock the seat belt connectors inside the open fixed end of the seat belt housing. When a passenger is present, the strain gage sensors will provide electrical responses to the applied bending, stretching, or compressing. The response will then be transmitted to the computer programmable memory for processing of other task like the seat belt check. Safety seat belts and air bags are the most effective means for reducing the potentials of serious injuries and deaths in automobile accidents.

Together with the air bag classification system “11/585,274”, they provide some unique potentials of reducing the crash fatalities and injuries to a minimum. Yet, passengers still forget to use the seat belts and sustain fatal injuries in most accidents as a result. For individual protection, seat belts should always be worn before the vehicle is engaged in motion and when the vehicle is in motion. Which means some form of electrical energy would have to ignite the starting system of the vehicle. Once the vehicle is started and put to motion, this energy form will regenerate different rate of motion, which is a function of speed. Speed is the main determinant of how serious a crash can be. This speed is what generates the force that human body receives in a crash accident that had an occupant in the vehicle at the time of the crash.

However, it is true that people take forces of impacts for jokes, but without the use of seat belts and air bags on high-speed accidents, kids and pregnant women will always be punished by a very little impact force. Therefore, it is important that all occupants in the vehicle wear seat belts always. The proper positioning of the seat belt on occupant's body is very important during crashes, to give the occupants maximum protection and reduce the bodily injuries that one can sustain without these protections. Improper positioning of the seat belt can also cause injuries during accidents. However, without the seat belt, frequently people will loose their lives. Therefore, occupants should always wear their seat belts and observe all the regulations and attachments about the seat belts. Children and all occupants need protection when riding in a vehicle. So, it is a practical idea to see into it that, all children and vehicle occupants are restrained when riding in any vehicle. If a child or any occupant is not restrained, during accident, the occupant may strike the interior part of the vehicle. It should have been suggested that car safety restraints are designed in a way that would prevent the vehicle from starting, if any or all of the occupants are not belted. However, the present invention is designed to protect every individual in the vehicle.

Also, it prevents the vehicle from starting if any or all of the occupants are not wearing their seat belts. In addition, the present invention is designed to protect every individual in the vehicle. In part, it will prevent the vehicle from starting when any or all of the occupants of the vehicle are not wearing their seat belts. The processor will check to make sure that all occupants are belted. If any of the occupant is not wearing the seat belt, the processor will assign a “0” signal to the control module to initiate the shut off of the ignition switch. The control module will then activate an audiovisual or human voice response to alert the driver of the vehicle about the specific seat location number bearing the unbelted occupant. If the occupant is still not belted, the control module will then energize the cutoff switch that will shut off the engine “5” minutes after the human voice response.

The time required to shut off the engine is adjustable, so that different states or the government could regulate the cutoff time. The computer system is programmed to recognize the number of seat belts that are available and the number of occupants that are supposed to fill the seats, through the use of the counter or accumulator. The counter is embedded inside the seat belt processor and receives all the load cell signals each time an occupant takes any of the seats. All signals are in binaries with lots of transistorize switches kicking on and off on time for the signals to be transmitted to other devices. The present invention is a smart seat belt buckling system that senses and recognizes the number of occupants that are on the seats. The control module signals the cutoff switch when any of the occupants is sensed to be unbelted. Once the seat belt is buckled and the vehicle in motion, a magnetic switch mechanism (magnetic cylinder) will activate a lock. The lock is to prevent the occupants from unbuckling the seat belts until the vehicle comes to a complete stop and the key switch turned off or the override switch pushed in.

When the seat belt is buckled, the optoisolator switch will enable electrical means that will activate the lock that will keep the seat belt fixed-end and the moveable-end in place, to prevent unbuckling of the seat belt while the vehicle is in motion. That is, once the engine is started and the occupants are belted, they will not be able to unbuckle the seat belt unless the engine is shut off or the override switch is closed. When the override switch circuit is closed or the ignition switch turn off the magnetic cylinders will then de-energized the magnetic field. The applicant understands that many attempts have been made to improve on the automotive safety through the use of seat belts. The applicant also understands that once the seat belt is buckled, occupants occasionally get to the habit of unbuckling the seat belts. This type of behavior makes the seat belt useless and very chance taking when riding in a vehicle, when considering the number of unpredictable accidents that occurs daily. Therefore, it is the object of this invention to totally and precisely protect all occupants from unbuckling the seat belt when the vehicle is in motion or the engine running. It is understood that the object of this invention is not only to protect the driver alone, but also to protect every occupant therein.

The present invention does not prevent the ignition key from being inserted into the keyhole of the starting switch. The smart seat belt control system will let the driver insert the ignition key into the key slot, but other devices will check and count the number of occupants in the vehicle. Once the number of occupants is known, the seat belts on the counted seats will be checked for proper latching. If any occupied seat is found unlatched, a human voice chip will be activated to release a human voice-warning signal to warn the driver about the unlatched seat belt. The human voice chip will also release the specific seat number that has the unbuckled occupant.

The load cell will always check for the presence of an occupant. If the occupant is present and is a child, the processor will realize this fact through load cell to processor signal communication and check to make sure that the child-seat is properly secured and tensioned. The occupant seating position counter will assist the seat belt processor in knowing the number of occupants that are in the vehicle. It will also identify the seat locations that have the unbelted occupants and carry the signals to the processor. Also, the counter will carry all it's counting in the batch mode and allow the BIOS to talk to the processor. All the other devices use the BIOS to communicate to each other through signal communications. Accordingly, each time any of the load cell circuit is closed, the counter will signal the processor, which will then use the BIOS to process other switches to check for the seat belt buckling for the occupied seats. The counter will stop counting when the load cells are on their no occupant mode or opened circuit.

The processor will record in the memory, the number of seats counted every time the counter output a signal to the processor's input. The input signal to the seat belt processor is what the processor uses to feed in the other devices so that a proper and accurate protection can be ascertained. As the counter picks signals from the load cells, the other switches are energized to carry on their tasks. The voice chip is incorporated in the control module to warn of the unbelted occupant when detected. The voice chip response is the first output signal when an occupant is detected for not wearing the seat belt. The output latch relay will open at the end of each count, enabling the other switches to be processed. The control module will also check for the operation of the other devices and switches. If any malfunction switch is detected, the voice chip relay will activate a user define messages indicative of the problem quo for possible repairs. The control module will also check the optoisolator switch. If the seat belt is latched, the optoisolator will send a “1” signal to the control module to stop processing. If the seat belt is not latched, the optoisolator will send a “0” signal to the control module to continue processing. That is, the optoisolator controls 1/0 for isolation.

The optoisolating circuit uses a light emitting diode “LED” connected to the output of the isolator to suggest activation of the seat belt to the control module input. If the signal is “0,” the control module will send a warning human voice signal out to the driver, addressing the seat number and the unlatched behavior of the occupant. The cutoff switch will then be energized if the occupant is still not belted. The boot program for this computer device ROM and BIOS chip will always check to see if there is any occupant on any of the seats. All the information will then be sent to the address line. The boot manager also assumes control of the start up process and loads the operating system into ROM. The operating system chip works with the BIOS to manage all operations, execute all programs, and respond to signals from the hardware. Lots of transistorized switches are used in the present invention to create and transmit binary information for logical thinking inside the computer and speedup signal communication therein.

When the seat belts are connected, the mobile connectors for the seat belts will activate a magnetic switch. This switch will automatically signal the computer control module that the occupant is belted. The signal for an occupant present is “1,” and a “0” signal for an unbelted occupant. The seat belt actuating switch could be of different types. A “1” transmission is when the seat belt circuit is closed. A “0” transmission is when the seat belt circuit is opened. The seats are coded so that the computer counter can tell the exact seat number that has the unbelted occupant. An insulated cable that has an attaching block and terminals at each end is assigned to each seat belt positive ends. When the occupant is not belted, the circuit will be opened. And when the occupant is belted, the circuit will be closed, thereby letting current to flow through the coded line to the computer processor for the seat belts.

The double circuit system for the processor lets the processor read the “0s” and the “1s” in two-wire process. That is, two wires will enter the circuit, and if there is a current from the coded line, the line will leave with a “1” from the terminal. If there is no current, it will leave with a “0” from the other terminal. In case of any current failure, the seat belt can be disconnected manually, by recognizing that there is a “0” reading at the isolator. The arrangement of the electrically conducting wires for the seat belt circuit, which are used for signaling the computer when in closed or opened circuit, initiate a lock when closed. The lock is to keep the seat belt connectors locked at all times while the vehicle is in motion. That is, with the closed circuit occupants will not be able to disconnect the seat belt until the circuit is opened. This can only be done in two forms,

(1) The driver has to come to a complete stop and turn the key switch off to let the occupant unlock or unlatch the seat belt.

(2) The driver can come to a complete stop, while the engine is idling; he can use the omitting switch (override switch) to let the passenger unlatch the seat belt by pushing in on the switch. The override switch is a push-in button type switch. When pushed in, it opens the circuit, thereby disconnecting the flow of current and also breaking the field for the magnetic lock. This lock can be designed to use different locking means, which also includes a plunger locking means.

The opening of the latching circuit could only be enforced when there is a restriction to current flow. This restriction is initiated by the omitting switch (override switch) or by the key or ignition switch in the off position. The smart seat belt control system uses these protective measures to extend the protection of occupants in all types of vehicular accidents. In addition, the smart seat belt control system is so unique in that, it works in an automatic mode once the passenger takes any of the seats. That is, solely the presents and actions of the occupants transmit all signals while the vehicle is in motion. The seat belt edges are made of coated fine material. This is to prevent occupants from being cut by said seat belt edges when the vehicle is involved in an accident with the belt tensioned. The load cell, together with the optoisolator and the CPU, reads the occupant's weight, the vehicle current speed before the accident, and calculates the safe seat belt tensioning. This tension, which is weight dependent, is the applied tension that is required to hold the occupant on the seat, and give the air bag enough room for more effective deployment. The input-voltage to the seat belt circuit will decide the opposition to the flow of current. This current is monitored and compared to the ratio of the resultant current that leaves the circuit. The circuit is used to achieve the impedance matching for each seat belt. It also allows signals to be transmitted to human voice signals when the seat belt is tempered while the vehicle is in motion.

The smart seat belt control system can also incorporate a multiplexing technique to assign signals to all specific seat belt locations or paths. This technique uses a time division to provide independent transmissions of the several pieces of information about the passengers. The information is shared on time with the computer and the driver at frequent intervals. All signals are transmitted through a normally opened switch mode which occur when the occupant is present and not wearing the seat belt. A normally closed circuit is enabled when the occupant is present and wearing the seat belt. With the closed circuit, the sensors for each location will be in series so that the same current will be running through the system, until another occupant takes the other seats. When the seat belt is not worn, the circuit will be opened and an alarm or a human voice-warning signal will be transmitted for that seat belt location. When the said circuit is opened, the sensors will be in parallel. Accordingly, when the occupant latches the seat belt, the sensors will be activated, the circuit will then be closed, enabling current that will then activate the control module to disable signal communication to the cutoff switch.

The ignition switch for the vehicle is designed to energize the accessories of the vehicle. The exact arrangement for the smart seat belt control system depends on the number of seat belts that are in the vehicle. The sensitivity of the seat belt in relation to the key switch is set so that the seat belt will not trip the key without a person on the seat. One set of contacts for the key switch is assigned to each seat in the vehicle. Each time a passenger takes any of the seats in the vehicle, one set of contact will be closed for the air bag and the other opened for the seat belt, until the passenger latches or buckles up. With the opened circuit, the driver will not be able to start the vehicle. Which means future vehicles will prevent drivers from letting their vehicles idle for a long time without the driver's attention. That is, when the driver is not on the driver's seat while the engine is idling, the switch on the driver's seat will stay open. Thereby transmitting a “0” signal to the control module which will then activate the cutoff switch. Another advantage and uniqueness of the present invention is that, not many deaths will occur because vehicles were left running in garages while the drivers were upstairs sleeping.

Many have been killed with their entire family by inhaling the exhaust fumes, because the drivers left their vehicles running unattended while they were upstairs. Besides, some people have the tendency of letting their vehicles idle for a long time unattended. In some way, this practice is hazardous to our health and our environment. However, the present invention in “smart seat belt control system” invention also controls the maximum idle time that a vehicle can run when left unattended. If the vehicle was already running, with the opened circuit, the control module will energize the cutoff switch and the engine will shut off if the driver is not on the seat, or the passenger is still not belted. The weight reaction on the driver's seat will energize the coils of the other seats. When the driver is seated, the circuit on the driver's seat will close, letting the control module know that the driver is seated while the engine is idling.

In all, if there is an occupant in the vehicle and the occupant is not on the driver's seat, with the driver's seat being vacant, the control module will still shut off the engine until the driver takes the driver's seat. The seat belt processor has a counter that detects the seat that has an unbelted occupant and sends that signal to the control module. The control module will then signal the cutoff switch that will later shut off the engine “5” minutes after the warning signal is broadcast. With the present invention, the driver will not be able to start the vehicle unless the occupant is belted or the driver is on the driver's seat. The control module has a simple timing circuit that controls the amount of time to cutoff the key-switch if the passenger is still not belted.

The arrangement for the smart seat belt control system allows the audio messages to come on first, to let the driver know about the behavior of the passenger before the engine is cut off. With this arrangement, if the passenger decides to put the seat belt on after the audio warning signal, then the circuit will close and every other circuit will return to normal. However, with the advanced technology in the smart seat belt control system, once the seat belts are connected or latched, with the ignition key on, passengers will not be able to disconnect the seat belts without the key-switch in the off position. Also, the driver could let passengers disconnect the seat belt with the use of the omitting switch (override switch), which will let the passenger off while the engine is still running. Another unique advantage of this smart seat belt control system invention is that, it has no provision for an unbelted occupant. The time switch is connected in parallel with the key switch and carries the omitting switch (override switch), which is used to let off passengers. The same computer system for the Advanced Weight Responsive Supplemental Restraint Computer System for the air bag deployment is programmed to keep track of the unbelted occupants with the use of these incorporated devices. That is, if the occupant is not belted, the computer will pick the signal and process other devices to react to the unsafe practices.

Some many advantages of the smart seat belt control system are that, there will be no increased air bag pressure due to the fact that the occupant was not belted. Besides, if the air bag pressures are increased to protect unbelted occupants, there will be no protective limits for bigger or smaller occupants.

However, a new technology in the air bag industry has a variable control to give each individual a force that is proportionate to the individual's weight. So, by implementing the smart seat belt control system, occupants of all ages and sizes will be well protected with this smart seat belt control system and the advanced weight responsive supplemental restraint computer system's technology.

Again, all occupants are protected with this advanced seat belt technology in smart seat belt control system, despite the frontal or rearward seating position. That is, whether the occupant is seating in the front or at the back seat, they will all be protected by the smart seat belt control system. This smart seat belt control system does not discriminate by protecting only the driver. It does protect every occupant in the vehicle. The smart seat belt control system will let the car start if the driver or the occupant is not wearing the seat belt, but the system will shut off the engine if the driver attempts to engage the vehicle in motion with any of the occupant unprotected.

The smart seat belt control system will not let the engine start if the driver is not on the seat. With the advanced weight responsive supplemental restraint computer system, the individual occupants on the front seats safely control the inflation pressure of the air bag. While the buckling of the seat belts is monitored by the seats counter that checks all the seats for proper and safe buckling. Which means, the size of the occupants on the front seats, and not the absence of the buckling of the seat belts will generate the increasing inflation pressure for the air bag. Besides, the seat belts will always be buckled with this advanced technology. In addition, occupants will not suffer the presence and effect of the excess air bag deployment pressure with the presence of the smart seat belt control system. Protectively, the smart seat belt control system together with the advanced weight responsive supplemental restraint computer system guarantees a total safety for vehicles with air bags. Gratefully, vehicles without air bags will have their occupants well protected. Also, the smart seat belt control system does not only control the driver's seat belt latching but also controls the other seat belts and seating positions of the vehicle. This also prevents the vehicle from starting when there is no body on the driver's seat. Once the engine is started, the smart seat belt control system will also controls the entire safety devices and prevents the driver from driving the vehicle when there is an unbelted occupant.

Another unique future for the smart seat belt control system is that, once the seat belt is latched and the engine running, occupants will not be able to disconnect or unbuckle the seat belt when the vehicle is still in motion or the engine running. This means, occupants will always have their seat belts on at all times when the engine is running or the vehicle in motion. Any attempt to latch the seat belt for the sake of starting the vehicle will prevail with the present invention. This is because once the seat belt is latched while the engine is running or the vehicle in motion, the occupant or driver will not be able to disconnect the seat belt until the vehicle comes to a complete stop and the ignition switch turned off. However, prior attempts have been made to safeguard the life of the driver by not letting the engine crank if the driver is not belted. With these attempts, only the life of the driver is protected.

Also, with the prior attempts, once the engine is started, drivers can still unlatch the seat belt and still be able to continue driving without the driver or the occupants being protected. Accordingly, the smart seat belt control system is not discriminative in that, it protects every occupant in the vehicle. Some object of this invention is to prevent the vehicle from starting when there is no person on the driver's seat. Another object of this invention is to cutoff the engine if the driver leaves the driver's seat with the engine running for more than a specified time. That means vehicles will not be started if the driver is not on the driver's seat, even if all the occupants are belted. Which means, when the driver leaves the driver's seat, kids on the passenger's seats will not be able to start the vehicle when there is no one on the driver's seat. In part, the programmable memory will prevent kids of certain weight range, with the incorporation of the load cell, to get on the driver's seat and attempt to start the vehicle. The presence of any occupant will energize the load cell.

The load cell in turn will energize all the other switches after the presence of the said occupant is noticed. The counter to make sure that the occupants are belted will then check the switches. If the occupants are not belted, the counter will inform the seat belt processor to enable signal communication. The seat belt processor will then signal the control module, which will then energize a human voice chip warning response. At the end of the warning communication, if the occupant is still not belted, the control module will activate the cutoff switch and the engine will then be shut off after “5” minutes or at the programmed time. The same uniqueness of this state of the art invention of the smart seat belt control system follows that; no interference will exist between the insertion of the ignition key and the ignition key switch. The smart seat belt control system will rather prevents the occupants from unlatching the seat belt once the engine is running. This means every occupant a total protection with the uniqueness of the advanced weight responsive supplemental restraint computer system.

The decision making for the air bag in advanced weight responsive supplemental restraint computer system will let the smart seat belt control system to function automatically. The system is programmed to cutoff the engine “5” minutes after the normal audio warning of the unbelted occupant or at the programmed time. The computer keeps track of everybody in the vehicle with the use of the load cell, to make sure that all the occupants are protected. A detailed record is provided for any presence of an occupant. The rapid decreases in cost for microprocessors and associate elements are bringing the computer-based system into almost every advanced safety and technologies. Therefore, the development of this advanced passenger restraint is less costly, very affordable, and will allow every passenger and driver to stay within the law. A device like the smart seat belt control system will be exceptionally hard not to be used by occupants. This device also will constitute significant differences to the fatal accidents and injuries. The low cost of the microprocessor of this device is what is leading to the development of what is called “SMART PASSENGER RESTRAINT”.

The smart seat belt control system is based on its ability to monitor the presence of the passengers on any of the seats, compares the belted information and the unbelted information with the data in the memory. It will then decide whether any of the two groups of information agrees with the stored data that has been programmed in the memory.

When the passenger is present, the computer will read a “1.” If the computer sees a “0” at the seat belt data, it will know that the passenger is not belted and will immediately signal the chip that has the stored human voice audio signal to response to the exact condition, for the exact message to be amplified to the driver.

The principle to this smart seat belt control system is based on the electronic line signals by the electronic control module. The signals are in analog, which varies with the amount of current at various seating points where seat belts and load cells are assigned. These signals are compared with the preset signal levels to form a digital signal, corresponding to the difference in the presence or absence of the passenger on the seat belt location. The digital signal is then compared with the actual current level corresponding to the seat pattern and the preset current level. By programming the current level to correspond to the configured seats, this device will not only protect adults, but will also protect any kid or person on the seat, regardless of the size. Since the output is a digital signal, this device can be programmed to check the locks at various high-speed crashes and also record the speed before the crash. That is, this computer device to help detect the crash speed, would record the speedometer reading before the crash. The omitting switch (override switch) is mounted on the dashboard. This switch is of the push in type, which is used for letting passengers off.

When any of the seat belts is connected, the little current that signals the computer will create a magnetic contact between the two metal connectors of the seat belt that will keep the latches locked at all times when the engine is running. When the belts are connected, a phototransistor and a light emitting diode “LED” will face each other across the open slit of the optoisolator switch. This diode is a simple switch, which is energized when the applied voltage provides a forward bias. The optoisolator is an optical-coupler, which consist of a light emitting diode “LED” input, optically coupled to a photocell. The photocell resistance is high when the LED is off “0 signal” for an unbelted occupant, and low resistance when the LED current is on “1 signal” for a belted occupant. The interface circuit for the photocell measures the light intensity inside the optoisolator.

The op-amp is the signal-processing interface between the photocell and the latching relay. This op-amp also compares the buckling switch on the LED when the seat belt is buckled, and the unbuckled signal when the seat belt is not buckled. The photocell is a sensor or transducer that converts light or optical energy into electrical energy so that the motion of the seat belt can be properly monitored. The optoisolator circuit monitors the light-intensity inside the fixed end of the seat belt and switch on the LED when the occupant is not belted. When the occupant is not belted, the light intensity will drop below the specified level. The conductivity or resistance of the photocell inside the optoisolator circuit changes under light exposure. This light exposure is initiated from the load cell switch when closed. Cadmium Sulfide “CdS” could be used for the design of the photocell. When the occupant is belted, the resistance will decrease while the light intensity will increase. The counter and the latching relay will then be energized. The interface circuit will then give an output voltage that is proportionate to the light intensity. This output voltage will also be proportionate to the load cell out put voltage. This voltage is then used to energize the coils of the seat belt tensioner so that a proportionate tensional force is ensured when the vehicle is involved in an accident. The generated voltage from the load cell's output is proportionate to the inverse of the resistance.

The control module is required to control the energy source of the switches. This control module will have the ability to control large amount of power with a minimum of control energy. Also, different types of control module may be used, but the description of the workability of the module employed in this process, calls for a control module that will conduct power in either one or two directions. However, only the module that conducts current in both directions will be mentioned.

The thyristor, which is a silicon-controlled rectifier, may be used for the control module process. Although there are other types that may work equally, only the thyristor will be mentioned in length. There are many types of thyristor that could be used. A thyristor is just like a diode with the exception that it can be turned on at any point in the circle. The thyristor has three terminals; the anode, cathode, and gate work in a defined sequence. That is, a current pulse is applied to the gate to start conducting.

Once conduction is started, the pulse is no longer necessary, and the silicon controlled rectifier will remain in conduction until the current goes to “0” or some other means is used to force it to stop the conduction process. The triac thyristor that could be employed for this design consists of two silicon-controlled rectifiers back to back. This allows current to flow in both directions when turned on. In addition, the triac is readily available in current rating to specific amps and also in voltage ratings. Accordingly, this triac thyristor consist of electrical isolation “optoisolation” so logic level voltages can turn it on. It turns on at the first voltage zero “0” after the control voltage is applied and the seat belt latched. It turns off at the first current zero “0” after the control voltage is removed or the ignition switch in the off position or the override switch pushed in. This will also prevent transients or voltage spike on both the source and the load.

The silicon-controlled rectifier is used because of the fast switching speed needed to keep every body informed of the necessary safety measures. The triac is very capable of providing such an adequate speed. In all, the silicon controlled rectifier works very closely with the computer logic circuit. The seat belt latching circuit also measures light intensity from the load cell as a signal communication that an occupant is present. An op-amp is also used as a signal-processing interface between the optoisolator and the latching circuit. This op-amp also compares the light emitting diodes “LED” for latching purposes when the load cell circuits are closed. When the seat belt is connected, the blinder will kick out. That is, the blinder will not be inserted into the slit when the seat belt is latched. The transistor will see the LED and energize a magnetic field between the two connectors of the seat belt.

When the key switch is off, or when the omitting switch is pushed in, the blinder will insert into the slit to disconnect or break the magnetic field. This will allow the occupants to unlatch the seat belt in an attempt to get out of the vehicle. Also, when the seat belt is not connected, the blinder will insert into the slit and the computer will know through signals that the seat belt is not connected. The seat belt magnetic switch is embedded inside the optoisolator switch, which is mounted on the fixed structural side of the seat belt. The applicant understands that the arrangement of the magnetic cylinder and the blinder can be configured differently. But the concept behind the smart seat belt control system is what the applicant is further claiming, to structurally safe the live of our love once in future accidents. The multi-mode control module will pick signals from the seat belt processor.

The counter tells the processor the number of unbelted occupants in the vehicle and the seat location of the said occupant. Again, the key switch, when turned on, and the seat belt connected, sends current to the isolator that will create magnetic field lines at the ends of the seat belt connectors. The field lines are strongest at the ends when connected and the engine running. The blinder will break the magnetic force each time the omitting switch is pushed in or the key switch turned off. There are lots of other locking system that could be used, as is mentioned that, some of the object of this invention is to prevent occupants from unlatching the seat belt when the engine is running or the vehicle in motion. Another object of the present invention is to shut off the engine when the vehicle is involved in any type of accident, preventing the pressurized fuel lines from busting out and fuel reaching the exhaust pipe or any other hot spot around the fuel lines and course flames.

The control module will also receive signals from the vibration sensor for rollover type accident, and from the collision sensor in frontal or rear-end type accident and activate the cutoff switch. Some of the many reasons why this state of the art smart seat belt control system shut off the engine are because drivers get panic when an accident occurs and lost control of directing the vehicle. By shutting off the engine will reduce the other consequences that are associated with panicking on the steering wheel. Also, on very severe accidents, fluid lines sometimes give away due to increased pressure on the lines caused by the impact force of the collision. With the exhaust temperature at certain degrees or any occurring sparks around the engine, a leaking fuel line will initiate flames and the vehicle will go on fire. Therefore, it is another object of this invention to eliminate further accidents and fatalities after the initial accident. This smart seat belt control system will let the control module activate the shut off system seconds after the air bag had deployed. The line of force is continuous between the north and south poles of the seat belt connectors.

This line of force or current flow draws these poles together to keep the seat belt locked at all times, when the vehicle is in motion. The material used for the seat belt connectors would have high permeability that will allow the material to conduct magnetic flux. The magnetic flux density will measure the concentration of the magnetomotive force of the seat belt connectors. That is, a strong magnet will depend on the heavy concentration of the magnetic flux. The electromagnetic reaction is temporal in this smart seat belt control system device. When current flows through the other end of the seat belt, and the connectors are latched, they become electromagnet.

The latching of the seat belts carry the principles to the operation of the seat belt activation of the optoisolator switches. The seat belt optoisolator switch linkage to the control module is energized when the ignition switch is closed. Once the control module is energized, the cutoff switch circuit will close, holding the control module in the energized state. When the occupant is not wearing the seat belt, the seat counter checking circuit and the latching circuits will close for that seat location. The cutoff switch will then be opened for the engine to shut off “5” minutes after the warning message. Seat belt switches 1, 2, 3, 4 are configured to use logic functions to close and open the counter and the latching circuits. That is, if the passenger is present and wearing the seat belt, the switch will be closed for that seat location. If the passenger is not wearing the seat belt, the switch will be opened for the said seat location.

The counter will then receive a “0” logical signal for the unbelted seat location and inform the processor that the occupant on that seat location is not wearing the seat belt. The processor will then notify the control module, which will then activate the chip to emit a human voice response, and a warning massage will then be voiced out. The control module will always activate a human voice message whenever the circuit for the seat belt location is opened. The ignition switch is connected to send power to the entire system of the present invention. All the components of the smart seat belt control system device are so sensitive in that, tempering with the seat belt connecting ends will not activate the system. Instead, it will audibly warn the driver that the occupant on the said seat location is tempering with the seat belt. Also, a vibration detector is attached and linked to the system to sense rollover type accidents and activate the cutoff switch to shut off the engine.

The effectiveness of the vibration sensor or detector will depend on the proper application and programmed installation. The use of the cutoff switch in any collision or rollover type accidents is to prevent fire hazards or any other type of accident that may occur after the original or initial occurrence. Therefore, proper adjustment of the sensitivity of the vibration system is necessary to avoid false cutoff from vibration caused by bumps. In addition, all accidents that are severe enough to activate the air bag will trigger the cutoff switch “5” seconds after the air bag had deployed. This is to prevent the engine from continuous idling and also to stop any other accidents that could result if the engine stays running after the accident. The time switch provides no time for an unbelted occupant. The advantage of the time switch in the present invention is to make sure that every occupant riding in the vehicle is protected.

The time delay gives the occupant enough time to comply with the law of wearing seat belts when riding in a vehicle. Through out the delay time, the warning massage will be operative for the time duration of the programmed delay intervals. After the delay time has elapsed, the control module will energize the cutoff switch and the engine will shut off when the programmed time elapses. The time switch is connected in parallel with the cutoff switch. When the warning signal is operative, the cutoff switch circuit will stay close. After the end of the delay, or the end of the warning message, the cutoff switch will then kick open and the engine will be shut off if the occupant is still not belted. If the occupant decides to wear the seat belt during the delay, the time switch will be opened and the cutoff switch will then be closed. The computer keeps track of all the activities around the occupants, the air bag, and the seat belt functions. The computer is programmed to check the seat belt latches on any of the occupied seat. The load cell provides unique information about the occupants present. However, the entire device is designed to monitor the wearing of the seat belt before the vehicle is engaged in motion to ensure that the occupants stay belted and safe, while the vehicle is in motion.

Vehicles without air bags can also take advantage of this smart seat belt control system. That is, the smart seat belt control system can use different sensors to sense the presence of an occupant even with older vehicles that have no air bag. In all, the smart seat belt control system device can be readily installed in older vehicles.

The time constant for the time delay is very important in this smart seat belt computerized device because the timing and the warning response time determines the performance of the smart seat belt control system. The device can use different time constant circuit. However, only the RL time constant will be described here, to carry the programmable assignments. The RL time constant is the inductor and resistor that are used to design the time circuit for the advanced weight responsive supplemental restraint computer system and the smart seat belt control system. When current is flowing in the inductor, the current generates a magnetic field buildup around the inductor. If the current is interrupted, the magnetic field collapses very quickly. The magnetic field is allowed to collapse at a controlled rate by an intermediate condition between maintaining the magnetic field and allowing it to collapse rapidly. The resistor determines the rate at which the magnetic field collapses. This time constant is a measure of the time required to broadcast the audible human voice warning message and the time to shut off the engine. The time constant is the specific amount of time required to obtain 100% of the programmable task of the smart seat belt control system.

Power line transients are ensured to protect any failure within the computer and the electronics. When a passenger seats on any of the seats, the passenger will input a present-signal on the load cell. The load cell circuit will then close and output the occupant present-signal that will energize the seat belt check-switch or counter. The counter will then check to make sure that the switch for the occupied seat is closed. When the switch for the occupied seat is closed, the latching relay will be energized to check if the seat belt for that seat location is latched. The seat belt check-switch or counter is closed only when an occupant takes any of the seats. The latching relay switch is only energized when the seat belt check-switch is closed. The energizing of the latching relay is momentary. Therefore, each time the latching relay is energized, switch “A” will be closed. Once the latching relay is energized, contacts “B” will close, holding the latching relay in the energized state after switch “A” is opened. All the other contacts will follow the same sequence of operation. The seat belt and the latching relay are arranged so that the contact of seat 1, which is the driver's seat, will supply power to the coils of seat 2, seat 3, and seat 4. The computer is programmed to recognize a pattern of switches, and no occupant will be able to start the vehicle if the occupant is seating in any seat other than the driver's seat. That is, the smart seat belt control system technology is one of the best technologies designed to protect all occupants of all sizes.

The moveable end of the seat belt has a built in coil in its housing which is rotate-able. The coil is properly winded on two shafts that have wheels at each end. The wheels are rotated as the coils receive collision signal from the collision sensor. A stopper plunger is engaged between the wheels when the coils complete its windings. The seat belt processor energizes the winding of the coil. That is, the occupants weight from the load cell and the speedometer information of the vehicle are send to the CPU that will compute the tension needed to keep the occupant on the seat when the vehicle is involve in a collision. The computed tension for the said occupant is then sent to the seat belt processor that will program the coil for that seat belt housing to rotate and tension the occupant appropriately on the prescribed seat location when a collision is sensed. The other object of this invention is to ensure maximum seat belt tensioning means that is sufficient enough to keep the occupant on the seat without causing any further injury to the occupant, or let the occupant be thrown out of the seat on impact. The tensioning of the seat belt and the tension on the belt are proportionate to the weight of the occupant on the prescribed seat location.

Another object of this invention is to provide a maximum supporting load that will hold the occupant on the seat during collision, while reducing the load acting upon the wheels. The stopper takes out much of the load acting upon the wheels when engaged.

The occupant's measured weight is very useful to measure the power to the coils of the rotating end or the seat belt tensioner. This power is so divided to signal the tensional circuit to energize the tensioning coil to rotate and tension the seat belt at a tensional force that is sufficient to hold the occupant on the seat. The energy to the coil of the seat belt tensioner is only necessary when the vehicle is involved in a collision of the prescribed magnitude. Very little current will be made constant at the coil. When the occupant's weight is input on the load cell, the load cell will then output this weight in voltage readings. All the voltage readings for the smart seat belt control system and the advance weight responsive supplemental restraint computer system are very small and they are read in milivolts. When the collision sensor sends a collision signal to the seat belt processor, the seat belt processor will signal the tensioning coils on the occupied seats so that the coils could be energized and adjust to the appropriate tension needed to safe-guard the occupants from injuries.

The unique object of this portion of the invention is to provide a variable tensioning means, since occupants are thrown off their seats with different forces for their different weight values. That is, for each occupant, the power needed to rotate the coil to provide a safe tension on the said occupant upon collision is P=I*E. The voltage from the load cell is E. This voltage is the occupant's weight value and all the computations of the rotations of the coils are carried on in binaries. The voltage E, multiplied by the constant current I, provides the necessary pressure that is needed to activate the coil to generate a tensioning force that would be compared to pounds per inch, sufficient enough to hold the occupant on the seat without causing any further injuries. The coil will receive a constant current I, and upon receiving the weight signals in voltage reading E, will influence the number of rotations of the coil that will safely protect and tension the occupant, without causing any further injury to the said occupant. The ground for the coil is located at the mounting casing of the coil housing.

The heart of the smart seat belt control system is the interface module inside the control module that communicates with the seat belt processor and converts the weight of the occupant and the collision force input into series of signals that the coil can handle. These signals are then sent to the coil tensioner to act upon, and influence the appropriate number of rotations of the coil that will initiate the amount of tension of the seat belt that will then keep the occupant on the seat when a collision is sensed. Signals may be sent in one wire at the same time. The transmission of the signals in this multiplexing technique would prompt other devices like the air bag accelerometer to programmable select only the signals that are intended for its use.

In the process of trying to determine the cost of building the smart seat belt control system, seat belt manufacturers would realize the very low cost. It is seen here that the same parts are used for the control of the smart airbag deployment force and the smart seat belt control system. The computer system for the advanced weight responsive supplemental restraint computer system is designed to accept the components of the smart seat belt control system. Therefore, the only additional future to the computer is the seat belt processor, the variable electronic tensional coil, the latching relay, and the optoisolator. All the other components are designed to work as described in the body of the present invention, to better improve on automotive safeties.

These advanced weight responsive supplemental restraint computer system and the smart seat belt control system technologies, are the DY-2Ksmart. Where the airbag, DY-2KsmartA, is differentiated with respect to A, dY/dA=2Ksmart and the seat belt, DY-2KsmartS, is differentiated with respect to S, dY/dS=2Ksmart. Together, they are DY-2Ksmart. A technology designed for the next century.

In all, the present invention is the advancement of occupant's protection to automotive safeties. Accordingly, it is a principal object of the invention to provide a supplemental restraint system having an accurate weight sensor to determine the presence and weight of a passenger.

It is another object of the invention to provide a correlation between the weight of the passenger and the deployment characteristics of the air bag.

Some of the other objects of the present invention are the many advantages as they are introduced in the art,

Occupants are programmed to always wear their seatbelts.

There will be no increased airbag pressure due to the fact that the occupant was not belted.

Vehicles without airbags will have their occupants well protected.

The engine is shut-off when any occupant is detected unbelted.

The connectors are locked when the vehicle is in motion to further protect occupant's unsafe habits

All the seatbelts are monitored when the ignition switch is turn on.

The system has 100% occupant's awareness and protection before the vehicle is engaged in motion.

The occupant to driver communicating means in relation to the seatbelt latching and the vehicle being in motion is unique.

The engine will cut-off and will not restart if the occupant is still not belted.

Occupants will always be held on their seats at all times while giving the airbag time to deploy more effectively.

The engine is cut-off at a preset time when the driver is not on the driver's seat, thereby preventing carbon inhalation at home garages if left idling unattended.

The development of the smart seatbelt control system is less costly and more effective in fatality reduction.

These and other objects of the present invention will readily become apparent upon further review of the following specification and drawings.

### BRIEF DESCRIPTION OF THE DRAWINGS

Similar reference characters denote corresponding features consistently throughout the attached drawings.

FIG. 1 is seen to represent a side view of an occupant 110 on a seat 10 of a vehicle using plurality of load cells 15 mounted between the seat mounting surface and the floor of the vehicle to control deployment of the supplemental restraint system of the present invention.

FIG. 2 is seen to represent the optoisolator circuit 70, a blinder 320 not inserted, an op-amp 35, the LED 74, the photo cell 73 and the magnetic cylinder 60 for monitoring and enabling a permanent lock on the belt ends when the vehicle is in motion.

FIG. 3 is seen to represent the optoisolator circuit 70, a blinder 320 inserted, an op-amp 35, the LED 74, the photo cell 73 and the magnetic cylinder 60 for monitoring and disabling a permanent lock on the belt ends when the vehicle is in motion.

FIG. 4 is seen to represent a computer system 500 with all internal elements that enablers signal communication.

FIG. 5 is seen to represent sectional view of the load cell 15 showing the strain gauges 11, a circuit diagram of other components of the present invention is further seen configured with computer 500.

FIG. 6 is seen to represent the seat belt 17 disconnected from their ends 46, and configured with a wheel 120 and a moveable coil 95, all seen to interface with the optoisolator 70 and the control module 25

FIG. 7 is further seen to represent at least a four seating positions all configured with at least a load cell 15, at least a switches 18 and include a second switch 88, the ignition switch 01, the cut-off switch 03, the seat belt latching relay 80 with points A and B as they are related to the control of the seat belts.

FIG. 8 is seen to represent the transistorized switches 04 and a block diagram of the primary components of the supplemental restraint system of the present invention.

FIG. 9 shows a gas canister 60, a sliding pot 61, the external layer 4, an internal layer 3, an opening 67 for the release of controlled release of gas 65, an air bag 1, an air bag sensor 8 and a combustion chamber 101 all forming the deployment components of at least an area of present invention.

FIG. 10 is seen to represent the interior of the vehicle showing the airbags 1, 2, the dashboard 300, and the pressure sensor 310 mounted on the dashboard for enabling signal communication when active.

FIG. 11 shows the seat belt monitoring control module 25 showing the front and rear seats circuits configured with a warning system in communication with the human voice chip 020, vibration sensor 300, and the optoisolator circuit 70.

FIG. 12 is further seen to represent at least a four seating positions all configured with at least a load cell 15 configured but for three seating positions, at least a switches 18 and include a second switch 88, the ignition switch 01, the cut-off switch 03, the seat belt latching relay 80 with points A and B as they are related to the control of the seat belts.

FIG. 13 is a clear view of the seatbelt ends 46 having at least a male connecting ends and a female connecting ends housing at least a harness for signal communications.

FIG. 14 is seen to represent the control unit for the instant invention configured to communicate various interior applications such as seatbelt usage, window up/down, door lock/un-look, heated mirror, engine component operation, wiper/washer on/off and to monitor electronic components operations.

### DETAILED DESCRIPTION OF THE PREFERRED EMBODIMENT

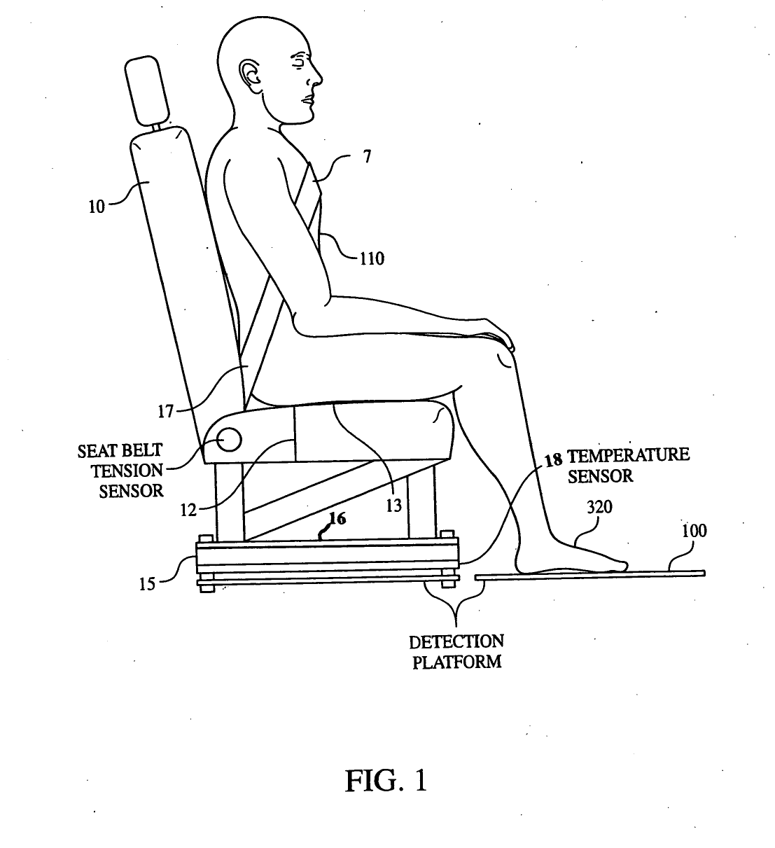

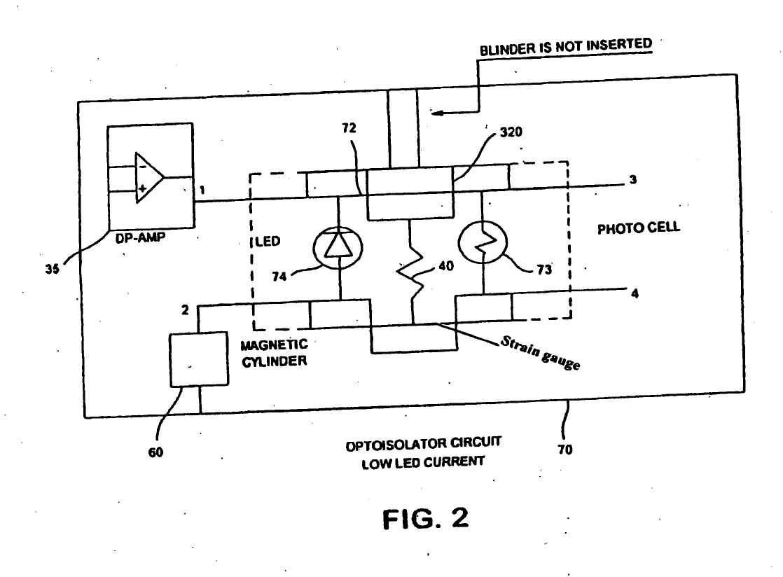

FIG. 1 denotes an exemplary configuration of occupants seats 10 configured with load cells 15, temperature sensor 18, a detection platform and switches to indicate when an occupant is seating. The load cell 15 is seen to be mounted between the seat mounting structure 16 and the floor 100 of a conventional vehicle. Occupant 110 is seen seating on seat 10 and held on the seat by seatbelt 17. Seatbelt 17 is further shown having a sensor 7, a seatbelt tension sensor and configured with load cell 15. FIG. 2 denotes an exemplary configuration of an optoisolator circuit 70, configured with at least a magnetic cylinder, a strain gauge, a LED, and a photo cell in communication with at least a blinder 320.

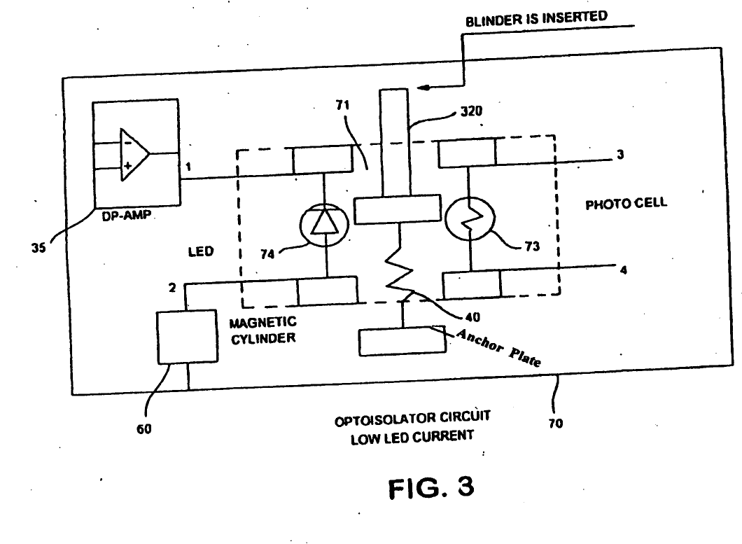

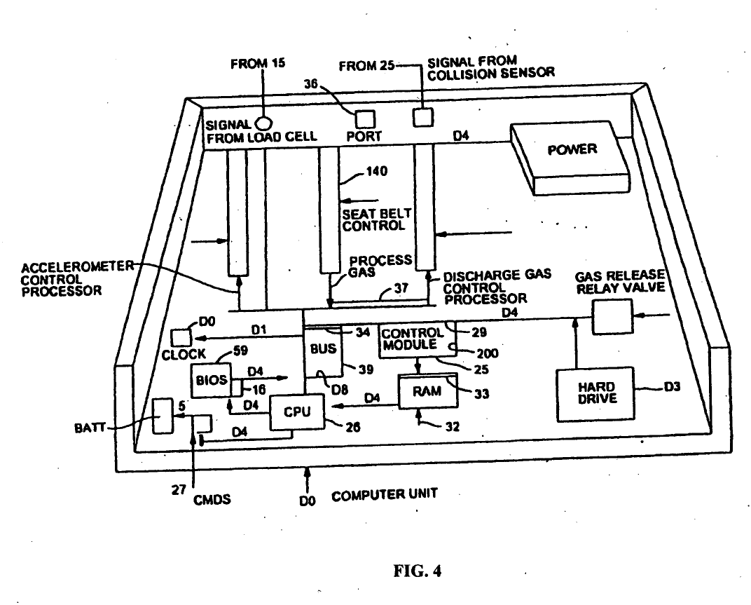

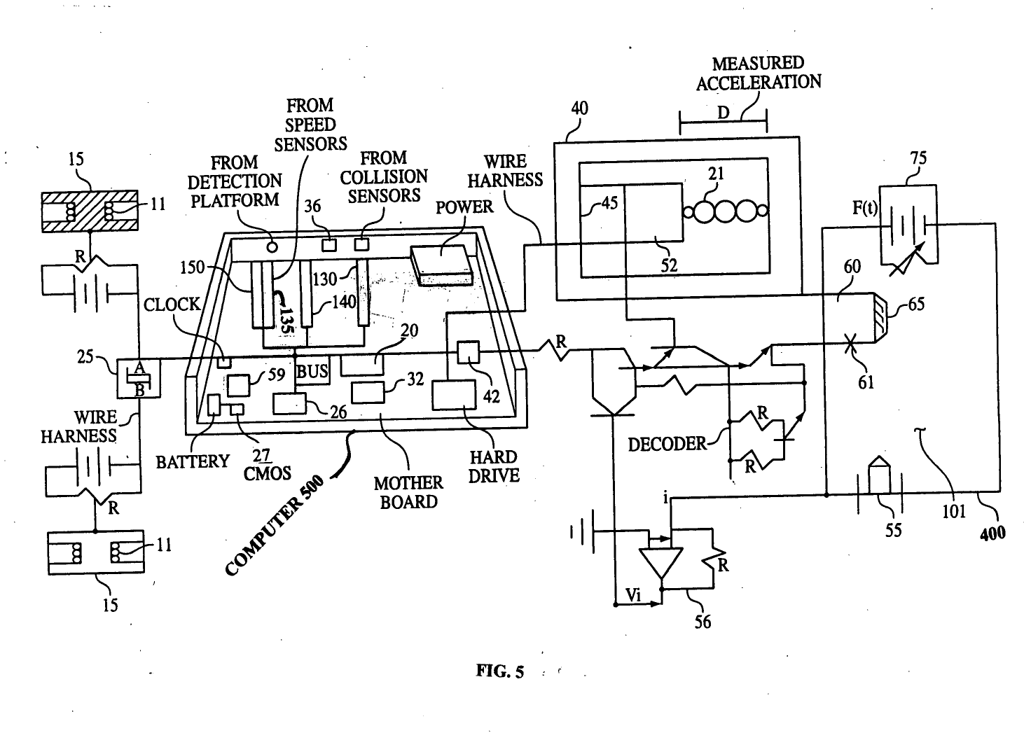

FIG. 3 denotes the optoisolator circuit showing the blinder insertion and the anchor plate configured with the strain gauge. The optoisolator 70 is communicatively connected to a computer unit through a seatbelt control processor 140 as shown in FIG. 4. The computer unit 500 is further configured with a gas discharge processor, an accelerometer control processor, gas release valve relay 42 and a CPU. In FIG. 5, the accelerometer 40 is seen constructed with the accelerometer spring 21, the accelerometer crystals 45, and the accelerometer mass 52. The accelerometer is operatively connected to the gas current igniter 55, and the measured acceleration D is seen to represent components of the accelerometer 40 configured with the gas canister 60 having a gas release valve relay 42 communicatively configured for controlled releasing of gas 65 into the combustion chamber 101. A collision sensor 75 and a gas current igniter 55 are configured with the accelerometer 40 and operatively configured with the gas canister 60 through processors 130, 135, 140, and 150. Processor 130 is communicatively configured with gas canister 60. Processor 135 is communicatively configured with collision sensor 75. Processor 140 is communicatively configured with seatbelt tension sensor 600, seatbelt tension sensor 600 is shown in FIG. 1. Processor 150 is communicatively configured with accelerometer 40. Processors 130, 135, 140, and 150 are communicatively interactive through CPU 26. The reference number 65 is seen in FIG. 4 to represent the controlled release of gas 65. The reference number 67 in FIG. 4 is seen to represent the opening 67 of the gas canister 60 for the controlled release of gas 65 into the combustion chamber 101. As shown, the controlled release of gas 65 is pressured from the gas canister 60 through the opening of the sliding pot 61, into the combustion chamber 101 for ignition by the gas current igniter 55 therein, initiating a proportionate amount of deployment force of at least first air bag 1.

As shown in FIG. 3, the accelerometer 40 upon receiving amplified signal from the amplifier 20, enables line signals to the gas canister sliding pot 61, to open the sliding pot opening 67, as shown in FIG. 4. The sliding pot opening 67, enables the gas release valve relay 42, to activate the controlled release of gas 65. The controlled release of gas 65, when ignited by the gas current igniter 55, deploys the air bag intelligently with a force that is proportionate to the weight of the occupant 110. The energy generated by the accelerometer crystals 45 displaces the accelerometer mass 52 in the accelerometer 40, to generate a corresponding amount of electrical energy therefrom, such as might occur if accelerometer 40 is piezoelectric accelerometer. The applicant also understands that this high accuracy weighing system is also designed to carry in vehicle information about occupant 110. By incorporating a ROM 59 and BIOS, a RAM 32, and software program in communication with the load cell 15, enables recording of any and all the information about the weight of occupant 110. The BIOS provide basic control over the load cell 15 and is stored in the ROM 59.

The ROM 59, which is a special chip, contains instructions and information in its memory that can not be changed, whereas the RAM 32 is primary memory storage for the occupant 110 information. The accelerometer 40 generates electrical energy when put under mechanical stress. Applying pressure on the surface of the accelerometer crystal 45 creates the measured stress; this is measured acceleration D initiated by the occupant's 110 applied weight on the seat 10 responsive for enabling signals to enable the stress. The measured acceleration is then passed on to the accelerometer 40. The accelerometer converts the measured acceleration corresponding to the weight of the occupant 110 into an acceleration value corresponding to the proper amount of acceleration at which the air bag 1, 2 would have to be deployed to protect the occupant 110 in the event of a collision.

The electrical energy generated by the accelerometer crystal 45 will displace the accelerometer mass 52 in the accelerometer 40, and the displacement force will react on the accelerometer spring 21, enabling the accelerometer spring 21, to contract to an amount proportionate to the occupant 110 applied weights on seat 10. The force reacting on the accelerometer spring 21 is proportionate to the weight of the occupant 110. When a collision is sensed, the collision sensor 75 will enable the control module 25, configured with the collision sensor 75, the control module 25, will then enable the amplifier 20 to amplify the signal from the load cell 15, to the accelerometer microprocessor 150, and the release gas control processor 130 configured with the gas release valve relay 42. The control module 25 will enable the gas current igniter 55, to ignite the controlled release of gas 65, inside the combustion chamber 101 for the air bag 1. The force created during the combustion inside the combustion chamber 101, is the deployment force of the air bag 1.

The speed of the vehicle and the collision threshold for enabling the activation of the airbag 1 determines the crash severity and allow the seat belt 17 to lock the occupants 110 in place while the air bag 1 protects the occupant's upper body from moving. The load cell 15 differentiates adults from kids with the highest degree of reliability. Occupants 110 are differentiated from objects through temperature sensor 18. The occupants 110 weight on the surface of the seat 10 and the occupants 110 weight on the floor 100 are transmitted to the load cell 15 to equal the occupant's input or weight. The weight information is kept constant so that even if the occupant 110 moves around the seat 10, the weight information at the address line 33 will not change. But when the occupant 110 finally leaves the seat 10, the erasable programmable read only memory-EPROM 34 will erase the occupant's 110 weight information from the address line 33. That is, when a new occupant 110 is seated, new information will be sent to the address line 33. Accordingly, the parameter of weight for the air bag to enable deployment is precisely determined.

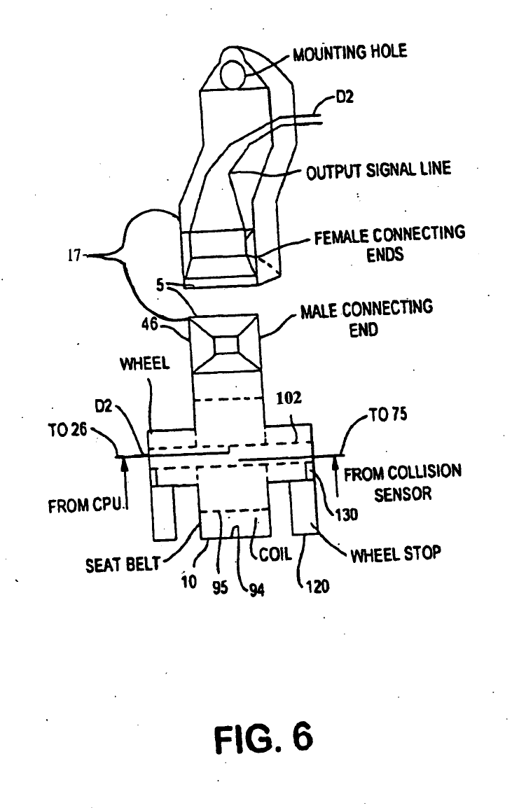

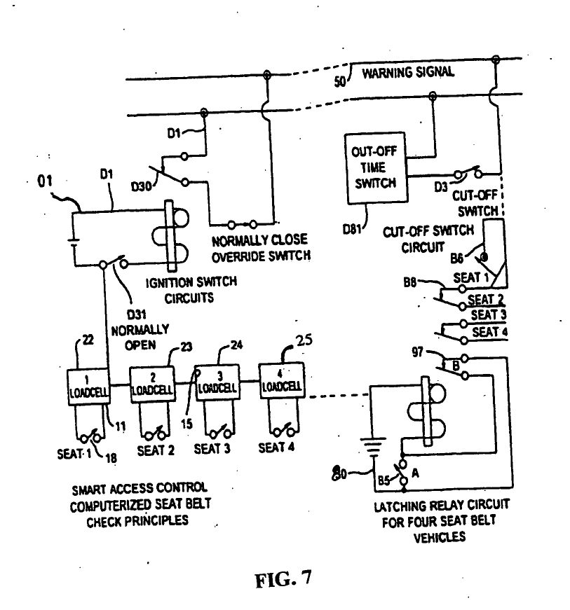

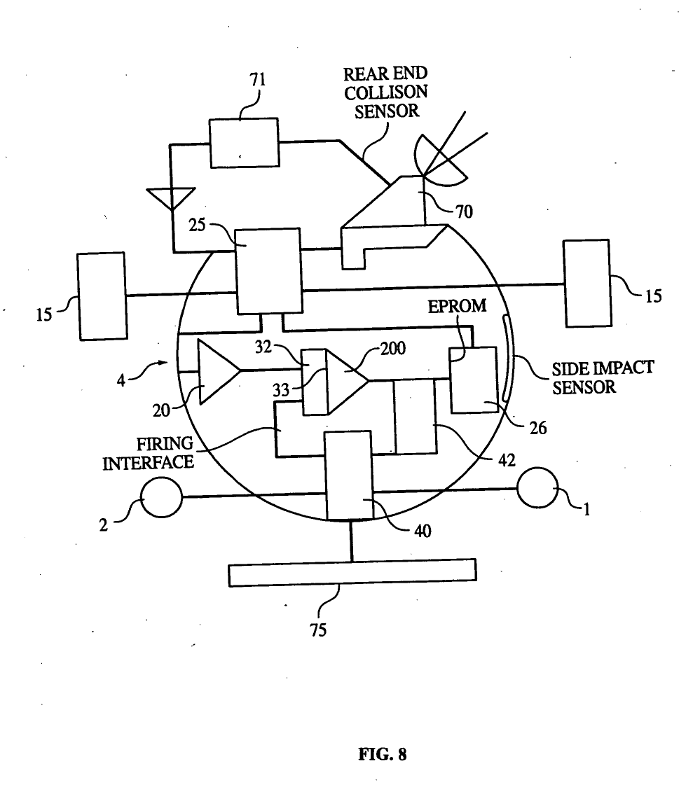

FIG. 6 further denotes a seatbelt designed with at least a connecting ends configured with a wiring harness and at least a connecting end communicatively connected to a coil. The communication signals from the harness are then communicated to the latching relay circuit as shown in FIG. 7 to check for the occupied seat and the seat belt latch for that occupied seat. FIG. 8 is seen to denote the computer unit configured with a CPU 26, a control module 25 and other elements of the present invention. FIG. 2 is an illustration of an optoisolator circuit with the blinder not inserted and configured with a LED, a photo cell, a strain gauge, a magnetic cylinder, and other elements of the present invention. FIG. 3 is seen to illustrate a similar embodiment of the present invention showing an anchor plate and the blinder inserted.

FIG. 8 denotes an exemplary elastration employing a rear end collision and uses a radar unit 70 to sense the imminence of a rear impact. The data from rear end collision is communicated to control module 25, which controls the detection of occupants 110 on seats 10 to enable the deployment of air bag 1, 2 with the proper force as discussed above. In a frontal impact of about 13.2 MPH, collision sensor 75 is activated. The speed of 13.2 MPH represents the threshold speed at which the efficacy of any air bag system should usually become activated. At collisions of below the 13.2 MPH, the air bag system tends to become less effective and expensive to deploy, thus the present invention can function even if the front impact is of an extremely low speed. The preferred embodiment of the present invention would not engage until occupant 110 is detected and the front impact of speed about 13.2 MPH and above is achieved. Thus, if the collision force is greater than the force normally created by a speed of about 13.2 MPH, airbag assembly 400 would be responsive because at speed 13.2 MPH, when an on coming vehicle is driving at above 13.2 MPH, the force would vary, thereby enforcing further injury. With the present invention, airbag assembly 400 is responsive to the speed of the vehicle, the occupants 110 weight, and the collision force during impact. The data stored in address line 33 is used as the proper force calibration, and the air bag 1, 2 would deploy with the proper volume of propellant.

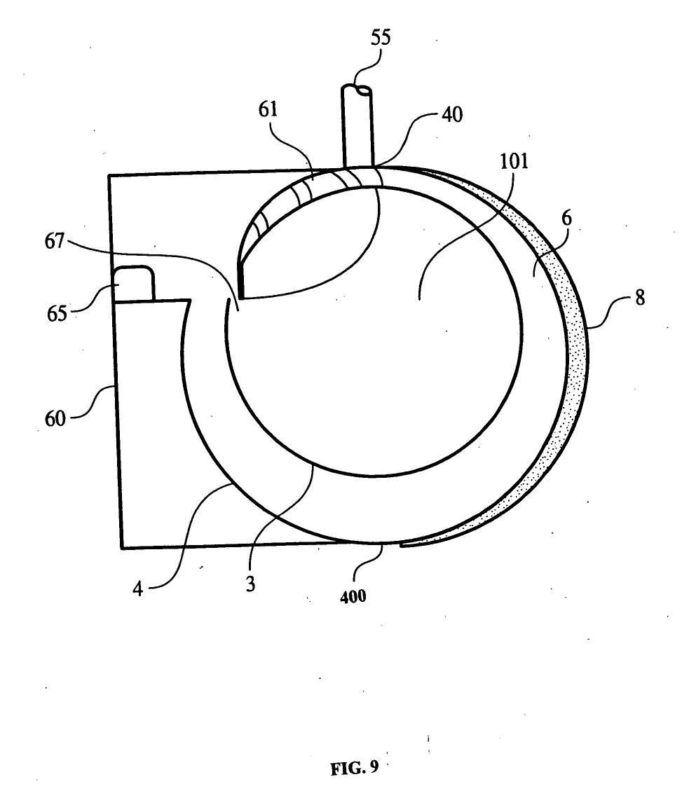

The reference number 65 is seen in FIG. 9 to represent the controlled release of gas 65. The reference number 67 is seen to represent an opening of the gas canister 60 for the controlled release of gas 65 into the combustion chamber 101. As shown, the controlled release of gas 65 is pressured from the gas canister 60 through the opening of the sliding pot 61, into the combustion chamber 101 and to be ignited by the gas current igniter 55 therein, initiating a proportionate amount of deployment force of at least first air bag assembly 400. In the illustration of FIG. 9, air bag assembly 400 has two layers 3, 4 to further minimize the impact of deployment. An internal layer 3 is the base of the air bag 1, 2 shown in FIG. 8, which is configured to be deployed according to the system described above. An external layer 4 is the cushion layer characterized by being foamy. There is a gap 6 between the two layers 3, 4 responsive for providing a cushion-like contact on occupant 110 shown in FIG. 1. The weight of the occupant 110 is correlated into an expected impact force and the desired amount of propellant or controlled release gas 65 for the air bag 1, 2 is ignited to provide the cushioning which balances this force, but does not over power occupant 110 or force occupant backward into seat 10 at such rate as to cause injury. The greater the volume of propellant or controlled release gas 65 for the air bag 1, 2, the smaller the gap between the two air bag layers 3, 4 upon deployment associated with such controlled energy. Thus, the two-layer air bag 1, 2 serves to maximize protection and prevent further injury for occupant 110.

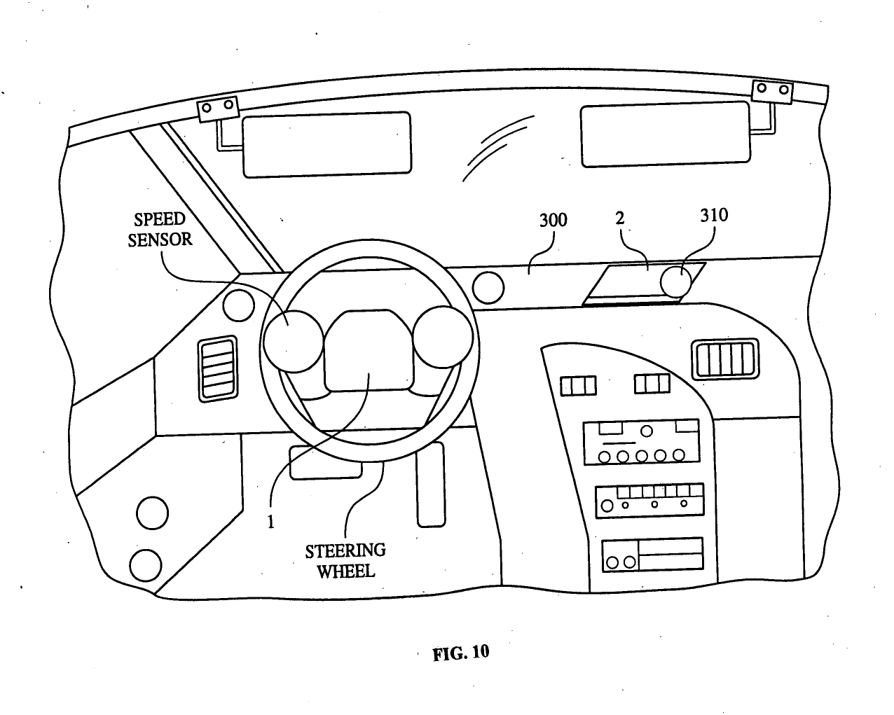

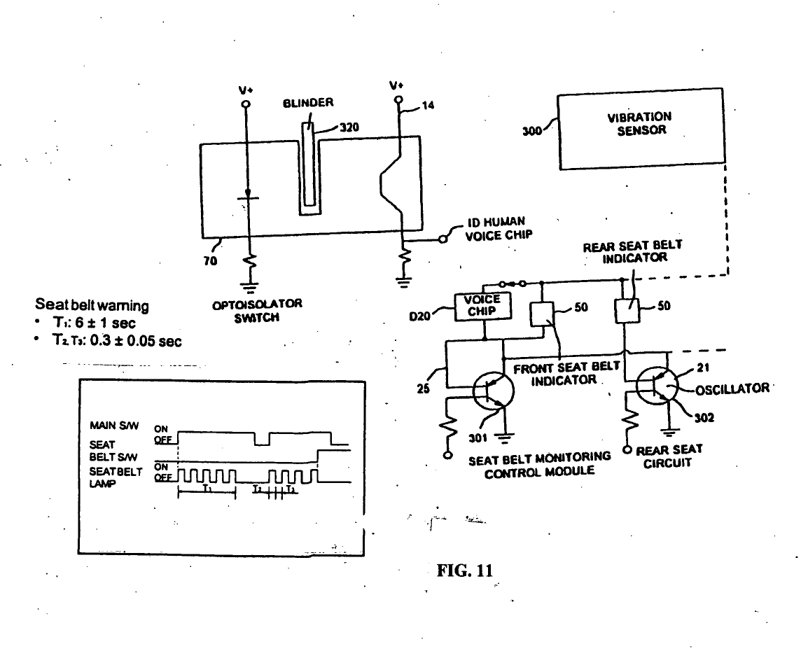

FIG. 10 denotes the interior of a vehicle configured with airbag 1, 2 and a pressure sensor 320 in communication with computer 500. The optoisolator switch is configured with a seat belt monitoring control module as shown in FIG. 11. Fig. There exist an out of time switch, an override switch and other switches configured to expedite communications. FIG. 11 denotes exemplary configuration of the seatbelt monitoring control module in communication with the optoisolator switch and comprising a time critical switch configuration responsive for enabling warning signals to occupants 110 when unbelted

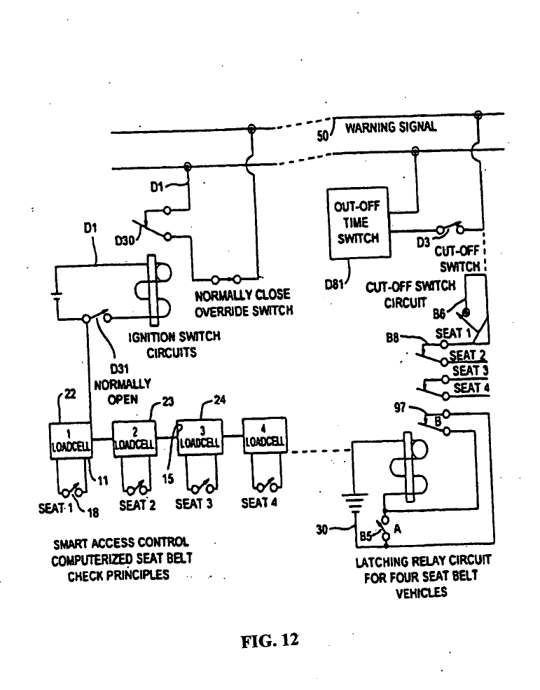

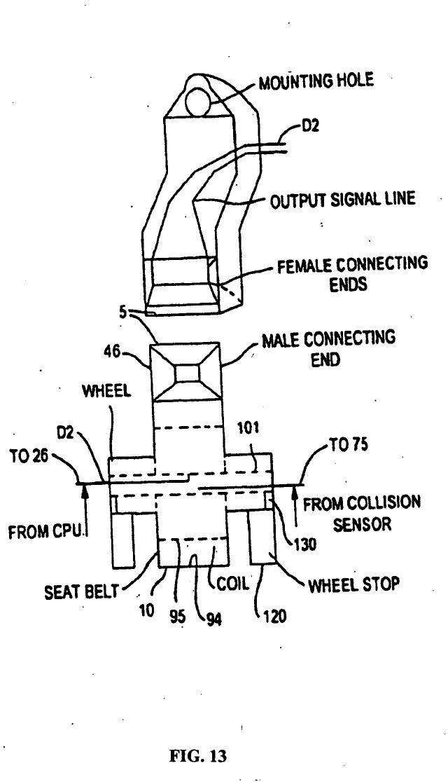

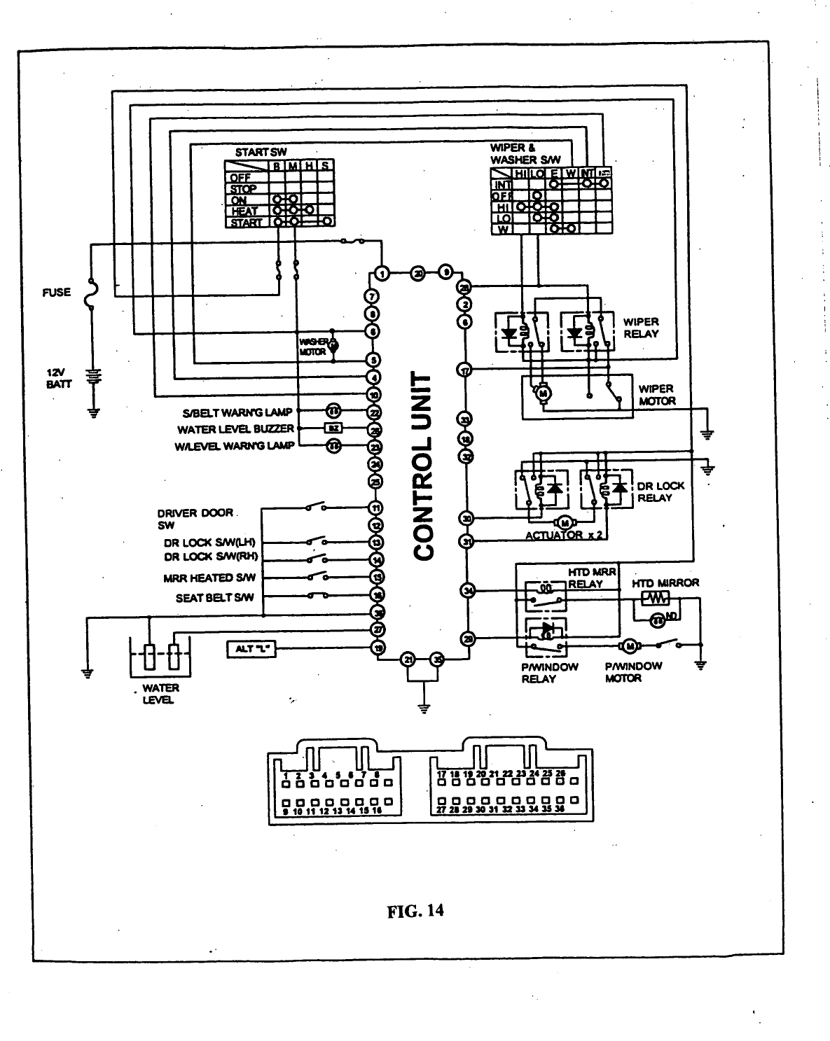

FIG. 12 denotes a smart access and control of the seatbelt system comprising a latching relay 80 configures with a cut-off switch and in communication with the seatbelt monitoring control module. FIG. 13 denotes an exemplary extension of FIG. 6 configured to stay in communication with a control module as shown in FIG. 14. The control module is shown configured within-vehicle electronic devices, including the windshield wiper/washer, the engine electronics, the door lock and window up/down control, such that when occupant 110 leaves seat 10 and the ignition key taken off and at least a window is lowered down, the control module, upon realizing that there is no occupant 110 on seat 10, will automatically enable the power window relay and the power window motor will then raise the window up. In other embodiment of the present invention, if occupant 110 is on seat 10 and the ignition key is turned off and the windows locked, the control module as shown in FIG. 14 will enable the power window relay and the power window motor will then lower the windows or turn on in-vehicle HVAC to allow ventilation to occupant 110.

Another embodiment of the present invention includes several conventional sensors 7, 8 at least one positioned on seatbelt 17 configured for restraining occupant 110 on seat 10, and at least one positioned on air bag 1, 2. Sensors 7 of FIG. 1 and sensor 8 of FIG. 9, which comprises magnetized elements, are configured to communicate to each other to enable the deployment direction of air bag 1, 2 away from occupants 110 head to further prevent any further injury.

The seat belt 10 is designed such that there is a female connecting end and a male connecting end as shown in FIG. 6. There is also a harness secured with the seat belt ends, such that communication signals are enabled when an occupant is seated and/or when a collision sensor communicates an accident. A tensional coil, a wheel and a wheel stop, a CPU are configured with the seatbelt. The preferred embodiment of the present invention includes the known standard configuration of the occupant's seat belt 10 as shown on FIG. 7. Plurality of load cells 15 are used to properly measure the occupant's precise and accurate weigh, enabling accurate adjustment of the tensioning coil 95 shown in FIG. 6.

The controlled release of gas 65, from the gas canister 60, as shown in FIG. 8, is accomplished by the gas release valve relay 42 communicatively configured with the sliding canister 60, which is open a specific amount as a result of the energy generated by the accelerometer 40. As a result, the deployment force of the first air bag 1 correctly matches the force of occupant 110 on the seat 10, occupant 110 and seat 10 shown on FIG. 7.

With reference to figures, FIG. 1, seat cushion 12 and floor 100 are shown respectively. Seat 10 is mounted on a load cell 15, which is disposed between the seat mounting frame 16 and floor 100 of the vehicle. The load cell 15 ascertains the weight of the seat 10 and the occupant 110 therein. A temperature sensor 18 is configured with the load cell 15 for distinguishing between occupant's 110 and any conventional luggage. Insight line angle configuration, temperature sensor 18 is position close to the feet leg angle of occupant 110, and has a conventional infrared sensor configured to sense occupants 110 body temperatures.

The energy generated by the accelerometer crystals 45 displaces the accelerometer mass 52 in the accelerometer 40, to generate a corresponding amount of electrical energy therefrom, such as might occur if accelerometer 40 is piezoelectric accelerometer. The applicant also understands that this high accuracy weighing system is also designed to carry in vehicle information about occupant 110. By incorporating a ROM 59 and BIOS, a RAM 32, and software program in communication with the load cell 15 as shown in FIG. 8, enables recording of any and all the information about the weight of occupant 110. The BIOS provide basic control over the load cell 15 and is stored in the ROM 59. The ROM 59, which is a special chip, contains instructions and information in its memory that can not be changed, whereas the RAM 32 is primary memory storage for the occupant 110 information. The accelerometer 40 generates electrical energy when put under mechanical stress. Applying pressure on the surface of the accelerometer crystal 45 creates the measured stress; this is the measured acceleration D initiated by the occupant's 110 applied weight on the seat 10 responsive for enabling signals to enable the stress. The measured acceleration is then passed on to the accelerometer 40. The accelerometer converts the measured acceleration corresponding to the weight of the occupant 110 into an acceleration value corresponding to the proper amount of acceleration at which the air bag 1, 2 would have to be deployed to protect the occupant 110 in the event of a collision, but without causing any injury to the occupant.

The present invention generally comprises the known standard configuration of an occupant 110 and driver's side seat belts 10 shown in FIG. 1 and FIG. 9, all configured in the same manner. FIG. 5 further denote a classification system for the occupants. When the ignition switch is turn on, electrical current of 5 milivolt energizes the load cell 5 configured with the computer system 500. When an occupant 110 seen on FIG. 1 takes on any of the seats 10, the load cell 15 will use the input from the occupant's body to start strings of events and in communication with the computer device memory 32 to enable data processing and computation. The post 36 inside the computer checks all the hardware components functionality to ensure that the hardware components configured with the CPU 26 are functioning properly. The post 36 later sends signals over specific paths on the chip motherboard 38 to the load cell 15 to account for the weight signals or responses, to determine the occupant's actual weight value. The input from the occupant's body when seated is received as force energy.

The load cell 15 will then output the force energy as weight and send to the control module 25, and the oscillator 21 will oscillate, indicative of signal received, enabling the control module to identify the seat 10 that has the occupant 110, before the motherboard 38 is enabled. The control module distinguishes front seat occupants from rear seat occupants through the front seat circuit 301 and the rear seat circuit 302. The chip motherboard 38 is where all activities are sent for processing. The result of the post reading is then compared with, in the CMOS 27 to enable accurate and timely responses to signal communication. At the completion of the post 36 readings, the boot program 08 will then check to see if there is any occupant 110 on any of the seat 10. This program will then send the occupant's information on weight to the address line 33 to avoid interference from vibrations and lightening current or thunderstorm. The CMOS is a memory where all P.C and hard drive configuration are stored, and also keeps track of the time and date of all information stored for the control of the smart seatbelt system.

When the ignition switch 01 is turned on, all the other accessories inside the vehicle will be energized, but the engine will not crank. The post 36 will check the hardware 09 functionality to ensure that the hardware components and the CPU 26 are functioning properly. The post 36 will then send signals over specific paths on the motherboard 38 to the load cell 15 to check for the presence of the occupants 110 on all the occupied seats 10. The chip motherboard 38, which is where all the occupant's activities are sent for processing, will enable the occupant's information from the post 36 to be compared with in the CMOS before processing. After all signals are processed, the boot program 08 will send the occupant's information to the address line 33 for safety storage. At this time the ignition circuit 01 will be open until the driver takes seat 1-22, which is the driver's seat denoted in FIG. 7. When the driver takes the driver's seat 22, the strain gauges 11, of the load cell 15, will provide electrical responses from the applied bending, stretching, or compressing of the strain gage 11. These electrical responses will then energize the other load cells 15, the computer 500, and also close the switch on seat1 22. By closing the circuit on seat1 22, the ignition switch circuit will then be energized so that the engine would be started.

The presence of an occupant will energize the load cell 15. The load cell 15 will then energize all the other switches 18, after the presence of the occupant 110 is noticed. The switch 18 will then turn on the optoisolator switch 70 that will then energize the latching relay 80 to ensure that all the occupants are belted. If any of the occupant 110 is not belted, the isolator switch will then send a “1” for signal communication to the seat belt processor 140 to enable the control module 25 energize the human voice chip 020 to then warn of the unbelted occupant 110. If the occupant 110 is still not belted, the cutoff switch 03 will then be enabled to shut off the engine after 5 seconds time lapses. The counter 50 will stay operative with the latching relay 80 and the optoisolation switch 70 to check out all the other seats by tracking the number of occupants 110 that are present. The Spring Control 20 for the Isolator Switch will then deploy a spring carrying current 40 that monitors the contacts of each seat belt connectors 5. When the current is restricted or cutoff, the spring will retract to unlock the seat belt connectors inside the open fixed end of the seat belt housing. The seatbelt indicator or counter 50, by monitoring the other load cells 15, and the seat belt circuits behaviors, will signal the seat belt processor 140 when any of the occupied seats 10 is found unbelted. The seat belt processor 140 will then energize the control module 25 that will activate a human voice chip 020 for response, to warn of the unbelted occupied seat number. When the ignition switch 01 is closed, the control module 25 is energized.

The cutoff switch circuit 03 will then be closed to allow the control module 25 in the energized state. When any occupant 110 is not wearing the seat belt 17, the counter circuit 50, and the latching circuit 80 will close for those seat location, enabling the blinder 320 to disengage, allowing the cutoff switch 03 to stay opened for the engine to shut off. When the vehicle rolls over in a roll over type accidents, the vibration sensor 300 will sense the roll over activities and activate the cutoff switch 03. The cutoff switch 03 will then shut off the engine after enabling the tensional moveable coil 95 to motion the seatbelt 17 to hold the occupant secured on the seat 10 prior to the flip. The vibration sensor 300 and all other initial sensors are programmed to respond to a delay, where for each delayed time the cutoff switch 03 will kick in at the end of the delayed intervals.

The time switch or timing circuit 001, which is connected in parallel with the control module 25, enables the cutoff switch 03 to respond to the cutoff signal faster. While the power line transient 310 ensures the protection of any failure that may occur within the computer and the electronics due to external voltages. The power line transients 310 filter out lightening effects or transient phenomenon from the computerized or electronic system so that the precise and accurate transmission of the occupant's weight information is guaranteed. When an occupant 110 seats on any of the seats 10, the load cell switch 18 will close, allowing the load cell output energy to energize the control module 25. The control module 25, after receiving signal communication from any of the load cells 15, will enable the counter 50 to count the number of closed load cell switches 18. Said control module 25 will enable the optoisolator switch 70 that will then energize the latching relay 80 to then check for the seat belt latching of the occupied seats 10 with closed load cell switches 18 to assure occupants safety.

When switch 18 for the occupied seat 10 is closed, the latching relay 80 circuit will also be energized so that the seat belt 17 for the occupied seat location is checked for buckling. The latching relay 80 circuit and the counter 50 circuit are closed only when an occupant 110 takes any of the seats 10. The latching relay switch 85 is only energized when the counter circuit 50 is closed. The energizing of the latching relay 80 is momentary, and each time the latching relay 80 is energized, switch “A” is closed. Once the latching relay 80 is energized, contacts “B” will close, holding the latching relay 80 in the energized state after switch “A” is opened. All the other contacts 87 will follow the same sequence of operation. The seat belt 17 and the latching relay 80 are arranged so that the contacts of seat 1 22, which is the driver's seat, will supply power to the coils of seat 2-23, seat 3-24, and seat 4-25.

The entire computerized system is programmed to recognize pattern of switches 88, and occupants will not be able to start the vehicle if the said occupant is seating on any seat 10 other than the driver's seat 22. The smart seat belt control system's technology will protect occupants of all sizes. The same uniqueness of this state of the art invention does not allow any interference to exist between the insertion of the ignition key and the ignition switch 01. The present invention rather prevents occupants 110 from unlatching the seat belt 17 once the engine is running. The device also gives every occupant a total protection with the uniqueness of the advanced weight responsive supplemental restraint computer system.

Other devices may be used in place of the load cell, like a pressurized or inflatable bag that would be mounted on the surface of the seat or beneath the seat. When an occupant takes the seat, the occupant's weight will displace x-amount of the stored pressure to a relay that will record the displacement as weight. The stored pressure is the maximum pressure to support the weight value of the said maximum. The weight of the replacing occupant will displace the stored pressure to the amount equal to the said occupant's weight value. If the weight of the occupant exceeds or equal the stored value, then the tensional force on the seat belt against the occupant will have a constant value. The recorded displacement will then be transformed into a weight value unit that the CPU will recognize. The CPU will then carry on the computation and calculation the same way like the load cell. Every process is the same when comparing the pressurized bag operation with the load cell operation. Therefore, for more accurate readings of the occupant's weight, only the load cell will be described in the entire description. However, the applicant is claiming the use of any bag, for the purpose of trying to adopt said bag to control the operation of the seat belt.

The load cells 15 are mounted underneath the seat 10 and bolted between the mounting metal base of the seats 10, and the floor 100 of the vehicle. Said mounting location of the load cells provides a solid support and attaching structural strength, while maintaining precise and accurate loading of the occupant's weight on the said load cells. The load cell 15 ascertains the weight of the passenger's seat 10 and any occupants' 110 therein. The load cell 15 can also be calibrated so that the weight of the seat 10 is the zero point reading.

Mounting the load cell 15 between the mounting metal base of the seat 10 and the floor 100 of the vehicle, or on rigid sliding or fixed surfaces, rather than within the passenger's seat 10, the present invention is more likely to obtain an accurate computation of the passenger's weight. Said weight is not subjected to any faulty readings due to the nature and configuration of the cushioning 12 between the thickness of the contact seating surfaces 13 of the passenger's seat 10 and the occupant 110 movement. The load cell 15 weighing system is a high accuracy scale with an in vehicle information system. The applicant also acknowledged the design of the high accuracy weighing system to carry in vehicle information about the occupant 110. Incorporating a ROM or BIOS memory 59, a RAM memory 32, and software program inside the load cell 15, to record any and all the information about the changing occupant 110. The BIOS provides basic control over the load cell 15 and is stored in the ROM 59. The ROM 59, which is a special chip for the said computer device, contains instructions and information in its memory that is not changeable. Whereas the RAM 32 is a primary storage for occupants weight information.

Accordingly, the present invention will display and record in the memory 32, all the necessary computed weights and also feed the CPU 26 with the information to allow calculation of the tensional force and other necessary information needed to aid the control of a variable tensional force for the seat belt 17. The tensioning of the seat belts 17 generates a force, where such generated force, with the use of the present invention, or by incorporating the software program inside the load cell 15, is proportionate to the computed weight of the occupant 110 on the sensed seat 10. The software program enables signal communication with the driver and the occupant 110 if necessary, to properly protect the occupants 110 from an uncalled behavior when the vehicle is in motion. All the seat belts 17 in the vehicle are supported and controlled by the smart seat belt control system. All the information and data are stored in RAM 32 before the processor 140 can manipulate the data. All data in the computer 500 exist as 0s and 1s representation of the occupant's weight in binaries. An open switch represents a 0, while a closed switch represents a 1.

When the key switch 01 is turned on, RAM 32 is a blank slate. The memories are filled with 0s and 1s that are read from the load cell output and transformed to the address line. When there is no occupant on the seat, every data in RAM 32 will disappear. The software 16, will recognize which data lines the pulses are coming from, and interprets each pulse as a 1. Any line on which a pulse is not sent is represented as a 0. The combination of 1s and 0s from eight data lines will form a byte of data. The RAM 32 functions as a collection of transistorized switches for the control room of this device intelligence. The 1s and 0s, which are ON and OFF switches, are used to control displays and also add numbers by representing the “0s” and the “1s” in the binary number system.

The binary number system will allow the computer to do any other form of math. Everything in the computer 500, words, and numbers software instructions will communicate in the binary number system. That means all the switches (transistors) will do all types of manipulation to compute the accurate tensioning of the occupant. The clock inside the computer 500 will regulate how fast the said computer should work, or how fast the transistorized switches should open or close. The faster the clock ticks or emits pulses, the faster the computer will work. The speed is measured in gigahertz, which are some billion of ticks per second. Current passing through one transistor is used to control another transistor; in effect turning the switches on and off to change what the second transistor represents as a logic gate.

The load cell 15, which is corrosion resistant high alloy steel with a dynamic load cell capacity of up to 1000 lb or more, is constructed from machined high steel beams with strain gauges 11 bonded inside. This load cell 15 is designed for vehicles with seat belts 17 or any restraint system like the air bags 1, 2. The strain gauges 11, which are electrical resistance elements, are properly sealed with sealant that will not allow moisture or any contaminant to disrupt the strained information.

When the occupant's body is seated into the seat where the load cell 15 is bolted underneath, the load cell 15 will process the input information and the weight of the occupant 110 will be applied on the strain gauges 11. The strain gauges 11 will then be strained to the weight amount of the weight of the occupant 110, and the load cell 15 will output this amount as the occupant's weight. Accordingly, the weight of the occupant 110 will create a reaction force that will be acted upon, and applied on the passenger's seat 10.

These applied weights will enable the strain gauges 11 to then be strained, compressed, pressured, or stretched in a corresponding amount, causing a change in voltage signal on the connecting lines. As the strain gauges 11 are stressed, strained, compressed, or pressured, the effective resistance of the strain gauges 11 will vary in an amount corresponding to the strains. The strain there across will vary in an amount corresponding to the actual weight of the occupant 110. Specifically, the induced voltage across each strain is divided so that a voltage signal is obtained that corresponds to the weight of the occupant 110 on the seat 10 where the gauges are strained.

The control module 25, which is a silicon control rectifier, will intelligently identify the seat 10 where the weight signal is outputting from, and manage the flow of the weighted data to the ROM 59. The ROM 59 will then receive the data about the occupant from the control module 25 and direct to the basic input and output system BIOS inside the ROM 59 program to the address line 33. The ROM 59 will then take the load cell 15 data about the occupant 110 from the address line 33 and turn over to the CPU 26 to manipulate. The CPU 26 uses the address line 33 to find and invoke the RAM 32 to insure an accurate calculation of the occupant's tensional force and any other information needed to feed the moveable coil 95, including deploying the air bag 1,2 when the impact force is determined. The coil 95, in the housing for the moveable end of the seat belt connector 5, is rotate-able. The coil 95 is winded on two shafts 101 that have wheels 120 at each end. The wheels 120 are rotated as the coils 95 receive collision signal from the collision sensor 75. A stopper plunger 130 is engaged between the wheels 120 when the coils 95 complete their windings, initiated by the energy from the seat belt processor 140. Said coils 95, will receive constant current I, as the ignition switch 01 is turn on. Upon receiving the weight signals in voltage reading E, from the load cells 15, said voltage reading will influence the number of rotations of the coil 95 that is needed to safely protect and tension the occupant 110, without causing any further injury to the said occupant.

The CPU 26 will calculate the occupant's tensional force value and send said information to the seat belt microprocessor 140 that will then use the said information from the CPU 26 to process and energize the moveable coil 95. The moveable coil 95 will then use the processed information from the CPU 26 and the standard 5 milivolts from the starting means to generate control energy for the occupant's tensional force value for seat belt control. Said control energy is proportionate to the load cell 15 output weight value of the occupant 110. The moveable coil 95, after receiving the 5 milivolts energy from the starting means and the information from the CPU 26, generates a tensional force energy on its windings that is proportionate to the occupant's weight and equal to the force needed to hold said occupant on the seat 10.

The number of rotation of the moveable coil 95 determines the tensional force on the seat belt 17 against the occupant 110. When said occupant 110 is replaced, the EPROM 34 will control that information at the address line 33. The EPROM 34 deletes stored information about a replacing occupant each time said occupant is replaced. When a collision is sensed, the amplifier 20 will amplify the entire device for a more speedy output to the moveable coil 95. Empowering all signal operations for the processors 140 and control module 25 to enable other signal devices, turning on and off different combinations of transistorized switch 04.

The processor 140 will receive signals from the said transistorized switches 04, activating it to handle the arithmetic logic unit that enables all data manipulations. The arithmetic logic unit is connected to the RAM 32 through the computer motherboard 38 to allow logical manipulation of data. The motherboard 38 and the interface module 200 will then receive data and coded instructions from the computer RAM 32. Data will travel 10 bits at a time and the branch prediction unit will then inspect the instructions to decide on the logic unit. The decoder will then translate the response from the load cell 15 into the instructions that the arithmetic logic unit can handle. The ALU processes all its data from the electronic scratch pad or register that is secured on the motherboard 38. All results are made final at the RAM 32.

The control module 25 for the present invention, which is a silicon-controlled rectifier, receives pulses at the gate 29 from the load cells 15 to signal other devices. These pulses are currents that are transmitted to energize other devices, like the cutoff switch 03, to shut off the engine when an unbelted occupant 110 is detected. The silicon-controlled rectifier, which consists of electrical isolation for logical operations, monitors the seat belt latches 5.

When the seat belt 17 is latched, or the first voltage zero is received, the control module 25 will turn on the magnetic cylinder 60. When the first current zero is received or the ignition switch 03 turned off, the control module 25 will turn off the magnetic cylinder 60. The control module 25 picks signals from the seat belt processor 140 that communicates with the computer system, the seat number of the unbelted occupant. When the occupant 110 is belted, the control module 25 will receive that signal and activates the line of force or current flow that will draw the magnetic poles for the magnetic cylinder 60 together to keep the seal belts locked while the vehicle is in motion.

The closing of the switch of seat 1 22, will energize the ignition switch 03 circuit that will enable the engine to crank. The seat belt processor 140 energizes all the logically transistorized switches 04, so that responses are transmitted on time, while the latching relay circuit 80 will always check for the seat belt latch 05 and energize the control module 25. The other load cells are energized only when the driver is on the driver's seat 22. The computer system will read stored information about the occupant's presents and energize the optoisolator switch 70 each time the load cell 15 is enabled. When the occupant 110 latches the seat belt 17, the optoisolator switch 70 will then transmit the latching signal to the computer counter 50. The counter 50 will then signal the control module 50 and the first voltage zero will be received.

The counter 50 will then check the number of occupants 110 that are present and compare that information with the number of seat belts 17 that are latched. If there is any difference, the latching relay switch 85 will close at switch A, and the control module 25 will then activate the human voice chip 020 response that will signal the driver about the unbelted situation. At the end of the human voice-warning signal, the control module 25 will automatically energize the cutoff switch 03 that will shut off the engine until the said occupant is belted. That is, the processor 140 will process the counter 50 to energize the latching relay 80 once an occupant is sensed. If the occupant is not belted, the processor 140 will receive that signal from the latching relay and assign a “0” signal to the control module 25, which will then energize the cutoff switch 03. When the seat belt 17 is latched, the optoisolator switch 70 will send a “0” signal to the latching relay 80 to stop processing of the said seat 17. If the seat belt 17 is unlatched, the optoisolator switch 70 will send a “1” signal to the latching relay 80 and the latching relay will then send a “0” signal to the processor 140 to continue processing. The- optoisolator switch 70 has a LED 74 that is connected to the output of the photocell 73 to suggest activation of the seat belt 17 and enables signal communication with the latching relay 80.

When the seat belt 17 is latched, a phototransistor 73 and the LED 74 will face each other across the open slit 71, of the optoisolator switch 70. The optoisolator switch 70, is an optical coupler, and depends on the input of the LED 74, to optically be coupled to the photocell 73. When an occupant 110 is not belted, the LED 74 will be off, a “0” signal and the photocell 73 resistance will then be high. When the occupant 110 is belted, the LED 74 current will be on, a “1” signal, and the photocell 73 resistance will then be low. The interface module 200 for the photocell 73 will measure the light intensity inside the optoisolator 70 for all two faces of the photocell and allow activation of the op-amp 35. The op-amp 35, which is a signal interface between the photocell 73 and the latching relay 80, will then amplify the latching relay 80, to compare the buckling signal and the unbuckling signal at the LED 74. The photocell 73, which is a sensor or a transducer, will then converts the light or optical energy into electrical energy to further monitor the motion of the seat belt 17.

When the occupant 110 is not belted, the light intensity will drop below the specified level. The optoisolator circuit 70 will monitor the light intensity inside the fixed end of the seat belt 17 and switches on the LED 74 when the said occupant 110 is not belted. The conductivity or resistance at the photocell 73 inside the optoisolator 70 will then change under this light exposure, which is initiated from the load cell switch 18, when closed. When the occupant 110 is belted, the resistance will decrease while the light intensity will increase. The increase in the light intensity will then energize the counter 50 and the latching relay 80, enabling the interface module 200 to then generate an output voltage that is proportionate to this light intensity. The output voltage from the interface module 200 will always be proportionate to the load cell output voltage for the identified seats. Said output voltage is the absolute weight of the occupant 110 on the seat 10. The changeable voltage is what is then used to energize the moveable coils 95 of the seat belt tensioner to enable variable tensioning effect on the occupant 110, so that an accurate and proportionate tensioning force is assured when the vehicle is involve in an accident.

The generated voltage from the load cell's output is inversely proportionate to the resistance therein. Accordingly, if the signal is “0,” the latching relay 80 will transmit a signal to the seat belt processor 140, enabling the processor 140 to signal the control module 25. The control module 25, after receiving said signal, will activate the human voice chip 020 for a response to the driver, addressing the seat number and the unlatched behavior of the occupant 110. If the occupant 110 is still not belted, then the control module will activate the cutoff switch 03 that will then be energized through the coded insulated cable 02. The insulated cable 02 could be of two-wire system to read the “0s” and the “0s.” When the driver's seat belt 17 is latched, the optoisolator switch 70 will activate the counter 50.

The counter 50 will then signal the seat belt processor 140 to process other switches 18 and also check for the other seat belt latching. When the counter 50 picks signal communication from the other load cells 15, the other switches 85 will be energized to carry on various assigned tasks. The voice chip 020, which is incorporated in the control module 25, warns of the unbelted occupant 110 when detected. This voice chip 020 is the first output to the driver when an occupant 110 is detected for not wearing the seat belt 17. The output from the counter 50 will energize the input to the latching relay 80 and open switch A at the end of each count, to enable the other seat switches 85 for the latching relay to be processed. The processor 140 being in signal communication with the counter 50 will pick the seat number of the occupant 110 that is not belted and feed the human voice chip 020 for responses.

When the seat belt 17 is latched, the arrangement of the electrically conducting wires for the optoisolator circuit 70, to the magnetic cylinder 60, will initiate a lock at the contact points of the seat belt connectors when closed. This lock is for preventing occupants 110 from disconnecting the seat belt 17 when the vehicle is in motion. When the seat belts 17 are connected, the metal connectors 46 on the mobile end of the seat belt 17 will trigger the circuit for the magnetic cylinder 60 that will keep both ends locked while the vehicle is in motion. The input voltage 14, for the optoisolator circuit 70, will decide the opposition to the flow of current. Said optoisolator 70 will also monitor and compare this flow to the resultant current that leaves the circuit to achieve the impedance matching for each seat. This impedance matching will help the occupant seating position counter 50, to assist the seat belt processor 140 in knowing the number of occupants 110 that are in the vehicle and to identify the seat location for the said unbelted occupant 110. The counter 50 will also check the operation of any other devices and switches. If any malfunction switch is detected, the voice chip 50 will activates a user-defined message to the driver for possible follow-ups and repairs. Signals are transmitted in digital and amplified by the op-amp 35 to timely speed up responses.

The tensioning of the seat belt 17 and the airbag deployment force are controlled by the occupant's presence and their body weight. The table below shows occupants weight values in decimals as they are converted to binaries at a constant speed of 13 MPH that will enable deployment of the are bag and variably tensioning the occupants on their seats, while allowing the airbag to be more effective. The table also shows that kids and adult passengers are all protected in the present invention. An example of binaries representing “ON” and “OFF” switches in “0s” and “1s”.

| | |
|---|---|
| WEIGHTS IN DECIMALS & | |
| BINARIES | SPEED “Minimum |
| “Off & on switches” | speed for deployment” |

| DECIMAL | BINARY | MINIMUM SPEED |
|---|---|---|
| 1 | 1 | 13 MPH |
| 2 | 10 | 13 MPH |
| 3 | 11 | 13 MPH |
| 4 | 100 | 13 MPH |
| 5 | 101 | 13 MPH |
| 6 | 110 | 13 MPH |
| 7 | 111 | 13 MPH |
| 8 | 1000 | 13 MPH |
| 9 | 1001 | 13 MPH |
| 10 | 1010 | 13 MPH |

The On and Off switching sequence may include defined weight limits per
vehicle make and model, selected by vehicle manufacturers or suppliers
to the manufacturers, but not limited to;

| | | |
|---|---|---|
| 450 | 111000010 | 13 MPH |
| 451 | 111000011 | 13 MPH |
| 452 | 111000100 | 13 MPH |
| 453 | 111000101 | 13 MPH |
| 454 | 111000110 | 13 MPH |
| 455 | 111000111 | 13 MPH |
| 456 | 111001000 | 13 MPH |
| 457 | 111001001 | 13 MPH |
| 458 | 111001010 | 13 MPH |
| 459 | 111001011 | 13 MPH |
| 460 | 111001100 | 13 MPH |

The computerized switches as shown above to represent the occupant's weights, are computed from a weight range of one pound to a weight range of four hundred and sixty pounds. Each weight is programmed to turn on and off combinations of switches representing the occupants weight reaction to safeties and protections.

When the override switch 06 is pushed in, current will be restricted from flowing through the optoisolator switch 70. This restriction to current flow will allow the occupant 110 to unlatch the seat belt 17 when desired. However, with the closed circuit, current will run through the device of the present invention and the said seat belt 17 will stay locked. When the circuit is opened, the sensors will be in parallel until the occupant 110 latches the seat belt 17, enabling the circuit to then be closed.

By closing the circuit for the override switch 06 will allow current to flow to the transistorized switches 04, and activates the control module 25 with a “1” signal so that the module 25, will discontinue signal communication to the cut off switch 03. The ignition switch 01 is arranged to ensure that, one set of contact for the said ignition switch 01, is assigned to each seat 10 in the vehicle. So that each time an occupant 110 takes any of the seats 10, one set of contact 030 will be closed for the air bag and the other set of contact 031 open for the seat belt 17. When the occupant 110 latches the seat belt 17, the contact for said seat belt 17 would then be closed, enabling the blinder 320 to set in the slit 72, allowing it to be a closed slit 72. The seat belt circuit to stay open is an indication that the occupant 110 is not belted and the unbelted behavior will prevent the driver from starting the vehicle. If the driver decides to get in the vehicle only to buckle up and start the vehicle, when the said driver leaves the vehicle idling, the engine will cutoff 5-minutes later.

The counter 50 will detect the seat belt that has an unbelted occupant 110 and switch-on the transistorized switches 04 that will then communicate through signals to the seat belt processor 140. The seat belt processor 140 will then switch on other transistorized switches to then enable the control module 25 to signal the cutoff switch 03, for possible shut-off, if the occupant 110 is not belted. The presence of the occupant 110 will energize the load cell 15 that will then energize all the other switches 18. These switches 18 will check signals to make sure that all the occupants are belted. If any of the unbelted occupants is noticed, the counter 50, will signal the processor 140, and the processor 140 will then activate the control module 25.

The control module 25 will then enable the cutoff switch 03. This cutoff switch 03 will be in a standby mode for about 5 minutes, which is adjustable, until the human voice response is broadcast, then said cutoff switch will shut off the engine if the occupant is still not belted. However, if the occupant decides to buckle up during the broadcasting sequence, the latching relay 80 will close-up the unbuckled signal for that seat and the control module 25, will receive said signal and switch back to normal mode. All signals are transmitted electronically in binaries, by means of the transistorize switches 04 turning different switching signals on and off in “0s” and “1s”. Other elements of this invention also transmit their signals electronically. When the occupants 110 initially take the seats 10, all the loaded load cells signals will be in analog.

The analog signals will then be converted to digital and compare to the preset signals to assure of the analog to digital signal transformation. The digital signals will correspond to the difference in the presence or absence of the occupant 110 on the seat 17, and the seat belt location. The said digital signal is then compared to the actual current level at each point on the seat pattern and the preset current level to confirm the presence and buckling of the occupants 110. When the seat belts 17 are latched, the little current that signal the computer system 500, will create magnetic field to enable permanent magnet at the contacts between the two metal connectors 46 of the seat belt 17, to allow the latches be locked when the vehicle is in motion. When the seat belts 17 are latched, a phototransistor 73 and light emitting diode “LED 74” will face each other across an open slit 71 of the optoisolator circuit 70. The diode 74 will be energized when the occupant 110 is belted and the applied voltage will then provide a forward bias.

All signals for this smart seat belt control system are transmitted electronically by the commands from the computer motherboard 38, the processor 140, and the control module 25. When the occupants take the seats 10, all the load cells signals from that point will be in analog. The analog signals will then be compared to the preset signals by the encoder 37 to form digital signals. The digital signals will correspond to the difference in the presence or absence of the occupant 110 on the seat belt locations. These digital signals are also used to approximate the seat belt length and the seat belt tensioning force that is needed, and used to secure the occupants on the occupied seats during collision or vibration. If there is a great difference in length, the CPU 26, will send signals to the control module 25 that will then activate the voice chip 50, to warn of the attempts to tamper with the seat belts 17. If this behavior is still not corrected, then the control module 25 will activate the cutoff switch 03 to shut off the engine until the behavior is corrected.

The digital signals are then compared to the actual current level at each point on the seat locations and the preset level to confirm the presence and buckling of the occupants 110. When collision is enabled, the CPU 26 will use information from the speed of the vehicle and the occupant's weight information from the RAM 59, to calculate the appropriate tensional force. Said tensional force is safer to be applied on the seat belt 17, for tensioning and protecting the occupants 110 from injuries, without strangling said occupants on their seats 10. This tensional force is calculated from the occupant's weight, the speed of the vehicle, and the collision force. The speed is stored each time the vehicle's acceleration is changed. When the driver slows down on the speed, the EPROM 34 will replace that speed information from the memory 32. The CPU 26 has all the necessary variables needed to compute the occupant's protection level when the efficacy of the impact indents the prescribed threshold limit that is indicative of the described collision force.

The CPU 26, upon receiving said collision force signal, will then assume a value and enable computation of the proper tensioning force needed to execute proper occupant safety. When the seat belts 17 are connected, a photo-transistor 73 and a light emitting diode 74 will face each other across an open slit 71 of the optoisolator circuit 70. The diode is energized when the applied voltage provides a forward bias. When an occupant is present and wearing the seat belt, the seat belt latching relay 80, will enable the interface module 200 to measure the light intensity as a signal indication that the occupant is present. A light intensity from the optoisolator switch 70 will send similar signals when the occupant is belted. The op-amp 35 will compare the light emitting diode “LED” for latching purposes when the load cell circuit is closed. The presence of any occupant energizes the load cell 15.

The load cell in turn energizes all the other switches after the presence of the occupant is noticed. The counter 50 then checks to know the number of occupants that are in the vehicle and activates the latching relay 80. The latching relay 80 checks all the seat belt latches for the occupied seats and informs the processor 140. The counter 50 to make sure that the occupants 110 are belted will then check all the switches 18. If any of the occupants 110 is not belted, the counter 50 will then inform the seat belt processor 140. The processor 140 will then signal the control module 25 that will then energize a human voice chip 020 for a warning response. At the end of the warning response, if the occupant 110 is still not belted, the control module 25 will activate the cutoff switch 03 and the engine will then shut off at the programmed time. The processor 140 will always check for belted occupants and assign a “0” signal to the control module 25 if the occupant 110 is unbelted. The seat belt processor 140 will then process other switching signals to ensure a timely seat belt buckling before the vehicle is engaged in motion. Each time the counter 50 picks signals from the load cells 15, all the other switches 18 will be energized.

At the end of each counting, the latching relay 80 will close switch A, enabling the other switches to be processed. The optoisolator switch linkage to the control module 25 is energized when the ignition switch 01 is closed. Once the control module 25 is energized, the cutoff switch 03 will close, holding the control module 25 in the energized state. And when the occupant 110 is not wearing the seat belt, the counter circuit 50 and the latching relay circuit will close for that seat location. The cutoff switch 03 will then be opened for the engine to shut off at the programmed time after the warning signal is broadcast. Seat belt switches on seats 1, 2, 3, 4 use logic functions to close and open the counter 50 and the circuit for the latching relay 80. If the occupant 110 is present and wearing the seat belt 17, switch 88 will be closed for that seat location. If the occupant 110 is present but not wearing the seat belt 17, switch 88 will be opened for that seat location.

The counter 50 will then receive a “0” logical signal from the unbelted seat location and send signal communication to the processor 140, indicative of the occupants behavior on the said identified seat location. The processor 140 will then send signals to the control module 25 that will then activate the human voice chip 020, outputting signal for the specific human voice response. The control module 25 will turn on at the first voltage zero “0” after the control voltage is applied and the seat belt 17 latched. It will turn off at the first current zero “0” after the control voltage is removed or the ignition switch 01 in the off position or the override switch 06 pushed in. The control module 25 will also prevent the transients or voltage spikes on both the source and the load.

The seat belt latching circuit for the present invention measures light intensity from the load cell 15 as a signal indicative of an occupant present and allow the op-amp 35 to process the signal interface between the optoisolator 70 and the latching circuit 80. The op-amp 35 will then compare the light emitting diode “LED 74” when the load cell circuits are closed, and when the seat belts 17 are connected, the blinder 320 will kick out and the magnetic cylinder 60 will then be energized. The seat belt tensioner for the present invention works in a control mode and automatically returns to its original tensional position after the preset time lapses. That is, the moveable coil 95 will reverse its motion 10 seconds after the occupant is tensioned. For this to occur, there most be no sensed vibration, or after a collision is sensed, the engine must be shut off with no detected vehicular motion.

The tensional return time is programmable and could be set to respond at different times, depending on the manufacturer's pre-tested and safe return time. The applicant also understands that, some elements could be eliminated to cut down on cost and the smart seat belt control system or DY-2KsmartS will still obey the law of buckling. However, the applicant is wholly claiming the concepts behind this smart seat belt technology. Recently, a family was involved in a rollover type accident. There was a child in the vehicle and the child was well secured on the child seat. The child's parents were not belted, only the child was belted. As a result, only the child survived. Therefore, there is a need for a better technology that will eliminate negligence like this. Neglecting to protect our own lives while riding in a motor vehicle is becoming a concern for most people.

No matter how involved the police and the government get in the matter, occasionally people still forget to protect their own lives. Accordingly, the invitation of a technology that will eliminate this negligence is the approach for the new century, to automatically protect every occupant in any automobile, and eliminate the fatalities when an accident does occur. “Buckle-up, it is the best thing to do”.

It is now understood that the present invention is not limited to the sole embodiment described above, but encompasses any and all embodiment within the scope of the following claims.

What is claimed:

1. A vehicle occupant detection and weight responsive apparatus for controlling the resistance of a restraint device, such that in an accident, an occupant of a vehicle impacts at least a seat belt without injury; comprising:
a. a pressure sensing device, for determining a weight value of the occupant;
b. a computer system, in signal communication with said pressure-sensing device, said computer system calculating a coil value based upon the weight value of the occupant and a collision force according to the vehicle speed;
c. a collision force sensor in communication with the computer system; and
d. a coil tensioner, in communication with said computer system, rotating a moveable coil per coil value associated with said weight value; and
e. means for controlling the seatbelt tension, wherein the seatbelt is rendered of sufficient tension to keep the occupant on a seat when a collision is sensed, but is not rendered of sufficient tension to cause impact injury to the occupant.

2. The occupant detection and weight responsive apparatus of claim 1 wherein said pressure sensing device further comprising an occupant sensing means, said means being in signal communication with said computer system, wherein said occupant sensing means sounds an alarm and/or voice auditory communication if the occupant does not have the seatbelt locked.

3. The occupant detection and weight responsive apparatus of claim 1, further comprising means for preventing unlocking of the seatbelt.

4. The occupant detection and weight responsive apparatus of claim 3, wherein said means for preventing unlocking of the seatbelt is active when the vehicle is in motion.

5. The occupant detection and weight responsive apparatus of claim 3, wherein said means for preventing unlocking of the seatbelt is overridden by a switch when the vehicle is in motion and or inactive.

6. The occupant detection and weight responsive apparatus of claim 1, wherein said occupant sensing means in communication with said computer system, wherein said computer system adjusts an air bag deployment speed if the occupant does not have the seatbelt locked.

7. A vehicle occupant detection means and weight responsive classification system for controlling the resistance of a restraint device, such that in an accident, an occupant of a vehicle impacts the restraint device without injury; comprising:
a. at least an airbag device;
b. a weight sensor responsive for occupants presents signal communication;
c. a microprocessor configured with said weight sensor;
d. a collision force sensor; and
e. a computer system configured with an erasable programmable read only memory “EPROM” device, in signal communication with said weight sensor.

8. A vehicle detection means and weight responsive classification system of claim 7, wherein said weight sensor comprises a load cell configured with at least a strain gauge.

9. The occupant detection and weight responsive apparatus of claim 1, wherein said means for controller the seatbelt tension further comprises a mechanism configured for controlling energy to said coil, said energy enables the buckling of the seatbelt connectors, wherein said connectors are made permanent when the vehicle is in motion.

10. The occupant detection and weight responsive apparatus of claim 5, wherein said switch further includes momentary/toggle switch configured with at least a seatbelt connector comprising at least an optoisolator switch having a LE connected to the output of a photocell for suggesting activation of the seatbelt and enabling signal communication to the latching relay.

11. A vehicle occupant detection means and weight responsive classification system for controlling the resistance of a restraint device, such that in an accident, an occupant of a vehicle impacts the restraint device without injury; comprising:
a. at least an airbag device;
b. at least a seatbelt device;
c. an erasable programmable read only memory “EPROM” device;
d. a pressure sensing device comprising at least one weight sensor secured beneath at least one seat configured to measure a weight value of said vehicle occupant to control the tensional force of said seatbelt and said airbag's deployment force for at least one airbag and at least one seatbelt when said vehicle is involved in at least an accident;
e. a computer system configured to connect to said erasable programmable read only memory “EPROM” device, in signal communication with said pressure-sensing device, said computer system calculating a tensional/deployment force value based upon the weight value of the occupant and a collision force according to the vehicle speed;
f. a collision force sensor in communication with the computer system;
g. at least one human body temperature sensor associated with said at least one weight sensor configured to distinguish human occupants from other objects; and
h. means for controlling the resistance of at least a seatbelt/airbag, wherein the seatbelt/airbag is rendered of sufficient tensional/deployment force to keep the occupant on a seat when a collision is sensed, but is not rendered of sufficient deployment tension/force to cause impact injury to the occupant.

12. The vehicle seat occupant detection means and weight responsive classification system of claim 11, wherein said pressure sensing device comprises at least a load cell configured with at least a strain gauge responsive for occupant sensing means.

13. The vehicle seat occupant detection means and weight responsive classification system of claim 11, wherein said EPROM further comprising means for correcting occupants weight data based on external conditions and/or changing occupants to effectively control detection and classification of said data to enable sufficient and effective seatbelt/airbag tensional/deployment force.

14. The vehicle seat occupant detection means and weight responsive classification system of claim 11, wherein said occupant sensing means communicatively configured with said computer system to adjusts seatbelt/airbag deployment speed based on at least a measured parameter; comprising: at least one or a combination of, said occupant's weight, a vehicle speed, and a collision force value, further including if the occupant does not have the seatbelt locked.

15. The vehicle seat occupant detection means and weight responsive classification system of claim 11, further comprising a plurality of seats each configured with at least one said pressure sensing device, said vehicle speed sensor and at least a restraint means configured with each of the plurality of seats, said pressure sensing device comprises means for transforming said occupant's weight into electrical energy and said collision sensor configured to enable initial signal for deployment of at least said restraint means when said collision severity exceeds a threshold limit.

16. The vehicle seat occupant detection means and weight responsive classification system of claim 11, wherein said collision sensor further comprising means for detecting an imminent rear-end collision.

17. The vehicle seat occupant detection means and weight responsive classification system of claim 11, wherein said pressure sensing device is a load cell comprised of at least a strain gauge, said load cell mounted between a seat frame means and the vehicle floor means.

18. The vehicle seat occupant detection means and weight responsive classification system of claim 11, wherein said seatbelt/airbag device further configured with at least said EPROM comprising at least an address line configured for each seat and communicatively connected to said pressure sensing device, and said pressure sensing device comprises a load cell operatively configured with a strain gage for transforming said occupant's weight into electrical energy.

19. The vehicle seat occupant detection means and weight responsive classification system of claim 11, wherein said EPROM further comprising means for controlling data about a changing occupant at said address line configured with each said seat.

20. The vehicle seat occupant detection means and weight responsive classification system of claim 11, further comprising means for correcting said seat occupant data at the address line when said data is influenced by at least an external force.

21. The vehicle seat occupant detection means and weight responsive classification system of claim 11, wherein said at least one weight sensor is operatively connected to said temperature sensor and disposed between said seat mounting structure means and the floor means of said vehicle.

22. The vehicle seat occupant detection means and weight responsive classification system of claim 7, further comprising a plurality of seats each configured with at least one weight sensor, a vehicle speed sensor and at least a restraint means and provided with each of the plurality of seats, said weight sensor comprises means for transforming said occupant's weight into electrical energy and said collision sensor configured to enable initial signal for deployment of said restraint means when said collision severity exceeds a threshold limit.

23. The vehicle seat occupant detection means and weight responsive classification system of claim 7, wherein said collision sensor further comprising means configured for detecting an imminent rear-end collision and enable deployment of said seatbelt/airbag device with a force proportionate to said occupant's weight.

24. The vehicle seat occupant detection means and classification system of claim 21, wherein said weight sensor comprises at least a load cell comprising at least one strain gauge configured to sense a force applied to it when said occupant occupies said seat, said strain gauge comprising electrical resistance elements configured to detect and measure resistance occurring when external strain is applied to said seat, wherein said external strain corresponding to said force from said occupant and is further converted into a corresponding electrical current for communicating said weight signal.

25. The vehicle seat occupant detection means and classification system of claim 7, wherein said computer system further comprises means for regulating the window of a vehicle when an occupant is sensed and the ignition turned off.
